(19) United States
(12) Patent Application Publication
(10) Pub. No.: US 2013/0179304 A1
(43) Pub. Date: Jul. 11, 2013

(54) METHOD AND SYSTEM FOR NOTIFICATIONS RELATING TO CONSUMER ACTIONS

(71) Applicant: Jason Swist, Edmonton (CA)

(72) Inventor: Jason Swist, Edmonton (CA)

(21) Appl. No.: 13/347,724

(22) Filed: Jan. 11, 2012

(51) Int. Cl. G06Q 30/00

(52) U.S. Cl. 705/26.62

(57) ABSTRACT

Shopping, the examining and purchase of goods or services from retailers is considered a leisure activity and an economic one with some people considering it recreational and therapeutic and others a task of inconvenience and vexation. Except for the advent of the Internet the fundamentals of shopping have not changed for centuries. However, at the same time the Internet provides unprecedented access to information such as maps, inventory, and pricing to users with fixed and portable electronic devices. Embodiments of the invention allow users to define needs and preferences against which the software application and software system establish results which may be presented to the user in a variety of formats allowing users to plan shopping activities to meet their preferences which may include visiting minimum number of outlets, travelling minimum distance within shopping environment, lowest cost, and stock of outlets as well as comparing Internet and “bricks-and-mortar” retail outlets.

### FIELD OF THE INVENTION

The present invention relates to retailing and more specifically providing enhanced services to consumers.

### BACKGROUND OF THE INVENTION

Shopping is the examining of goods or services from retailers with the intent to purchase at that time and involves the steps of actively selecting items and purchasing them. In some contexts it is considered a leisure activity as well as an economic one with some people considering it a recreational and diversional activity or even a therapeutic activity wherein an individual or a group visit a variety of stores with the premeditated intent to purchase a product. To others, shopping is a task of inconvenience and vexation.

Fairs and markets have a long history since man felt the need to exchange goods wherein people visited daily or weekly and were followed by shops where market traders were essentially permanently established. Such shops were specialized, with the exception of the department stores that were typically found in major cities from the 1850s which satisfy a wide range of the consumer's personal and residential durable goods product needs; and at the same time offering the consumer a choice of multiple merchandise lines, at variable price points. In the 1930s supermarkets appeared with their reduced employee requirements through self-service and focus to volume. Today self-service dominates in all sectors of shops. Accordingly, there have been three major phases in the shopping/trading world in the last 100 years. In a way, these link up into a full circle:

1. Customers would be served by the shopkeeper, who would retrieve all the goods on their shopping list relating to that shop or product category, e.g. meat, groceries, etc. Shops would often deliver the goods to the customers' homes.

2. Customers have to select their own goods, retrieve them off the shelves using self-service, and even pack their own goods or scan them to register their purchases. Customers deliver their own goods.

3. Customers select goods via the Internet. The goods are delivered to their homes by courier or mail as in phase one although the delivery is now decoupled from the vendor who may never actually possess the items which are shipped from the manufacturers or distributors directly.

Over time the village shops, town High Streets, and traditional downtown shopping areas have been replaced by shopping hubs of increasingly larger scale which can be found outside the older city areas within newer residential neighbourhoods. Such shopping malls, or shopping centers, are collections of stores across multiple retail categories, often including multiple retailers within the same category, and anchored by a department store type retailer. More recently shopping centers in newer residential areas or even out of the town/city completely are anchored by one of more hypermarkets, supermarkets, or “big-box” stores. Traditional High Street shopping and neighbourhood shopping continues through a combination of

Online shopping has completely redefined the way people make their buying decisions; the Internet provides access to a lot of information about a particular product, which can be looked at, evaluated, and comparison-priced at any given time. Online shopping supposedly allows the buyer to save the time and expense, which would have been spent traveling to multiple stores or malls, although at times the masses of information, traditional and online retailers, product offerings etc may mean the buyer spends longer searching online without any guidance/support from knowledgeable store personnel resulting in incorrect decisions, dissatisfaction and time returning/replacing the items purchased.

Stores are divided into multiple categories of stores which sell a selected set of goods or services although some stores provide goods and/or services across multiple categories. Usually they are tiered by target demographics based on the disposable income of the shopper and accordingly can be tiered from cheap to pricey. Similarly, shopping malls are similarly tiered with demographic based customer bases. Many shops which are part of a shopping centre, shopping mall, or neighbourhood are part of a retail chain in that they carry the same trademark (company name) and logo use the same branding, same presentation, and sell the same products but in different locations. The shops may be owned by one company, or there may be a franchising company that has franchising agreements with the shop owners, the latter most often found in relation to restaurant chains.

Accordingly, a buyer is faced with multiple options in respect of purchasing even a single item yet alone all the items they wish to purchase either on a weekly, monthly or annual basis. Consider a buyer in Edmonton, Alberta, Canada with a population of approximately 1 million people wishing to buy the new Stephen King book “Nov. 22, 1963.” They have 17 stores of the chain Chapters. Likewise another buyer in San Jose, Calif., USA with a population similarly of approximately 1 million people has 21 stores of the retailer Barnes & Noble from which to choose with approximately a 20 mile radius of the downtown core. Each has additionally tens of other book shops from competing retail chains as well as independents to choose from within the same area as well as online retailers such as Amazon and the online websites of the physical retailers.

Within the prior art Pettyjohn et al in US Patent Application 2009/0,304,161 entitled “System and Method Utilizing Voice Search to Locate a Product in Stores from a Phone” teach to a method for providing automatic voice recognition/responses for product location information in a store while using a phone. The method teaches to the user and/or customer answering a series of automated questions to help the user and/or customer locate the product within a single store. Accordingly Pettyjohn addresses the instance that the customer has already selected the store to visit and purchase the item or items from.

In a similar manner Elliott in US Patent Application 2010/0,262,554 entitled “in-Store Wireless Shopping Network using Hand-Held Devices” teaches to a method implemented upon a portable electronic device (PED) wherein the processor of the PED executes a shopping program to access a product database including product information, to process the product information to generate a shopping list comprising one or more products from the product database based upon user preferences or recipe information, and to provide guidance information on the display relating to product location in a store of the products on the shopping list. Accordingly Elliott, like Pettyjohn, addresses the instance that the customer has already selected the store to visit and purchase the item or items from.

Also within the prior art Lie in U.S. Pat. No. 7,775,430 entitled “Smart and Easy Shopping using Portable RF Transceiver-Enabled Devices and Fixed In-Store RF Transceivers” teaches to a system that stores and maintains a digital map and database to enable customers using portable devices within a store to access information about the location of products in the store and their availability. Customers can use portable devices to obtain the shortest walking route within a store to obtain a desired product based on fixed transceiver proximity to portable devices. As such Lie addresses the instance that the customer has already selected the store to visit and purchase the item or items from.

Deaton et al et al in U.S. Pat. No. 7,464,050 entitled “Method and System for Facilitating Consumer Purchases” teaches to a method of marketing with detecting product purchase information of a plurality of retail stores which includes price information and a shopping list. In response to receiving the shopping list the customer is provided price information associated with the shopping list for the plurality of retail stores. Accordingly unlike the prior art of Pettyjohn, Elliott, and Lie discussed above Deaton presents pricing for multiple retail outlets to the user but does not consider additional user preferences.

Accordingly, it would be beneficial for a buyer to be able to identify one or more items that they wish to procure, their shopping list, together with their preferences and be provided through use of a software application, either downloaded to their electronic devices or online, with a list of options with decreasing compliance to their preferences. It would be further beneficial where the item or items are available from multiple retail outlets of a single retailer that the buyer is provided with results that indicate the matching of these different retail outlets to user preferences which are not related to the item(s) specifically and may be independent of the cost(s) of these or include the cost(s) as part of the matching process.

According to embodiments of the invention exploiting a software application and/or software system in execution upon an electronic device local or remote to the user, the user may:
find items in a retail environment—where the user enters the item or items and is provided a location(s) of the item within a retail environment;
find items in a shopping centre—where the user enters an item or items and is provided a list of options of retail environments and their location within each retail environment;
establish a route within a retail environment based upon user preferences and user items of interest such as minimum distance, minimum number of retail outlets, etc;
price matching, wherein a user may establish that another retailer outlet is offering a better price but a retailer which meets user preferences will match; and
establishing automatically for a user based upon the user shopping list whether there are online coupons that can be retrieved for the user to redeem in their purchasing of items on the list.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to retailing and more specifically providing enhanced services to consumers.

In accordance with and embodiment of the invention there is provided a (will be completed by inserting independent claims when agreed)

In accordance with and embodiment of the invention there is provided a (will be completed by inserting independent claims when agreed)

In accordance with and embodiment of the invention there is provided a (will be completed by inserting independent claims when agreed)

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network supporting communications and interactions between devices connected to the network according to embodiments of the invention;

FIG. 2 depicts a portable electronic device supporting communications and interactions according to embodiments of the invention;

FIG. 3 depicts a shopping centre relating to an environment for communications and interactions according to embodiments of the invention;

FIG. 4 depicts schematic maps of the shopping centre in FIG. 3 relating to an environment for communications and interactions according to embodiments of the invention;

FIG. 5 depicts a map outlining shopping centres together with the shopping centre of FIG. 3 providing alternatives to a user of an application according to embodiments of the invention;

FIG. 6 depicts exemplary screen images presented to a user of an application according to an embodiment of the invention;

FIG. 7 depicts an exemplary sample screen image presented to a user of an application according to an embodiment of the invention;

FIG. 8 depicts an exemplary sample screen image presented to a user of an application according to an embodiment of the invention;

FIG. 9 depicts an exemplary sample screen image presented to a user of an application according to an embodiment of the invention;

FIG. 10A depicts exemplary sample screen images presented to a user of an application according to an embodiment of the invention;

FIG. 10B depicts exemplary sample screen images presented to a user of an application according to an embodiment of the invention;

FIG. 11 depicts an exemplary sample screen image presented to a user of an application according to an embodiment of the invention;

FIG. 12 depicts an exemplary sample screen image presented to a user of an application according to an embodiment of the invention;

FIG. 13 depicts an exemplary process flow relating to an application according to an embodiment of the invention;

FIG. 14 depicts an exemplary process flow relating to an application according to an embodiment of the invention;

FIG. 15 depicts an exemplary process flow relating to an application according to an embodiment of the invention;

FIG. 16 depicts an exemplary process flow relating to an application according to an embodiment of the invention;

FIG. 17 depicts an exemplary process flow relating to an application according to an embodiment of the invention; and

FIG. 18 depicts an exemplary process flow relating to an application according to an embodiment of the invention.

### DETAILED DESCRIPTION

The present invention is directed to retailing and more specifically providing enhanced services to consumers.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “mobile communication device” as used herein and throughout this disclosure, refers to a wireless device used for communication that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “network operator/service provider” as used herein may refer to, but is not limited to, a telephone or other company that provides services for mobile phone subscribers including voice, text, and Internet; telephone or other company that provides services for subscribers including but not limited to voice, text, Voice-over-IP, and Internet; a telephone, cable or other company that provides wireless access to local area, metropolitan area, and long-haul networks for data, text, Internet, and other traffic or communication sessions; etc.

A “shopping application” as used herein may refer to, but is not limited to, a software program that provides those accessing the shopping application with access to services including browsing, selecting, comparing, acquiring, purchasing, sending, requesting and storing items offered by one or more retailers. Additionally the shopping application may provide the user with services such as mapping, shopping list preparation, directions, and shopping centre matches relating to an item or items identified by the user for purchase. The shopping application may be downloaded to one or more portable or fixed electronic devices of the users, may access one or more servers associated with retailers and/or the shopping application software system, or may be accessed as a web based service without any downloaded application. The software system providing the shopping application to the user may be localized or distributed by the provider of the shopping system or cloud based.

A “user,” as used herein and through this disclosure refers to, but is not limited to, a person or device that utilizes the shopping application, either as a potential purchaser, controller of the shopping application, or an intended recipient of any purchases from the shopping application. A “Registered Party” as used herein may refer to a person, group, or organization that has registered with a shopping application and may or may not be the intended recipient of the items purchased. A “merchant” as used herein may refer to any seller of goods or services, either online or in a traditional store. A “buyer” or “customer” or “shopper” as used herein may refer to a person, group, or organization that has accessed a shopping application and who makes, purchases, or contributes to a purchase for themselves or another person, group, or organization. A “recipient” as used herein may refer to a person, group, or organization that receives a purchase from another person, group, or organization via the shopping application and a merchant. A “shopping application” as used herein may refer to, but not be limited to, a service provided to third parties, including but not limited to, buyers, customers, shoppers, recipients, and registered parties for activities including for example the identification, listing, selection, and purchase of goods and services. A “purchase” as used herein may refer to, but not be limited to, a product, ware, service, reward, donation, bequest, etc.

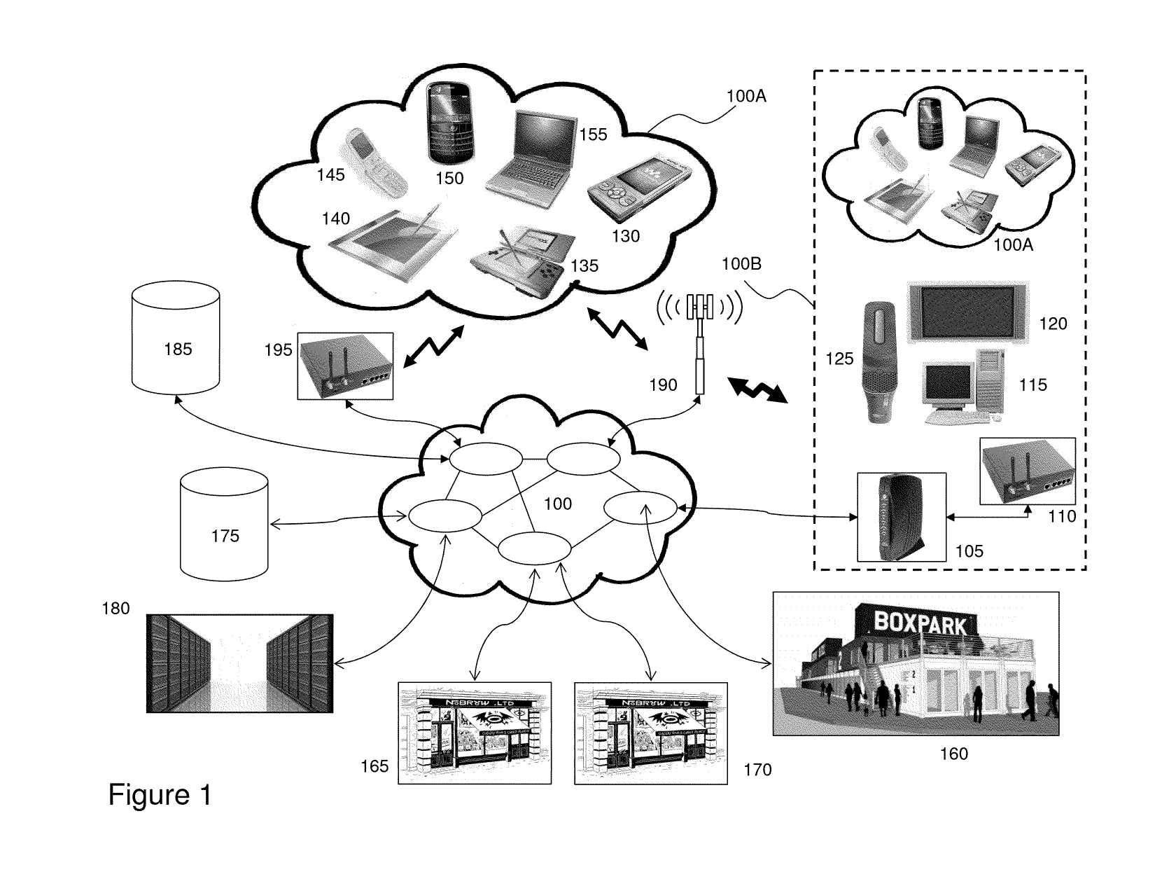

FIG. 1 depicts a network supporting communications and interactions between devices connected to the network according to embodiments of the invention with geographically separate first and second user groups 100A and 100B respectively interfacing to a telecommunications network 100. Within the representative telecommunication architecture a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second wireless access points (AP) 195 and 110 respectively which provide Wi-Fi cells for first and second user groups 100A and 100B respectively.

Within the cell associated with first AP 195 the first group of users 100A may employ a variety of portable electronic devices including for example, laptop computer 155, portable gaming console 135, tablet computer 140, smartphone 150, cellular telephone 145 as well as portable multimedia player 130. Within the cell associated with second AP 110 the second group of users 100B may employ a variety of portable electronic devices such as those identified with first group of users 100A identified above including for example, laptop computer 155, portable gaming console 135, tablet computer 140, smartphone 150, cellular telephone 145 as well as portable multimedia player 130. Additionally within the second group of users 100B may employ a variety of fixed electronic devices including for example gaming console 125, personal computer 115 and wireless/Internet enabled television 120 as well as cable modem 105.

Also connected to the network 100 is cell tower 190 that provides, for example, cellular GSM (Global System for Mobile Communications) telephony services as well as 3G and 4G evolved services with enhanced data transport support. Cell tower 190 proves coverage in the exemplary embodiment to first and second user groups 100A and 100B. Alternatively the first and second user groups 100A and 100B may be geographically disparate and access the network 100 through multiple cell towers, not shown for clarity, distributed geographically by the network operator or operators. Accordingly, the first and second user groups 100A and 100B may according to their particular communications interfaces communicate to the network 100 through one or more communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access.

Also communicated to the network 100 are first and second servers 175 and 185 respectively which host according to embodiment of the inventions multiple services associated with a provider of the software system(s) and software application(s) associated with the shopping application including, but not limited to, dictionaries, speech recognition software, product databases, inventory management databases, retail pricing databases, shipping databases, customer databases, and software applications for download to fixed and portable electronic devices. First and second servers 175 and 185 respectively may also host for example other Internet services such as a search engine, financial services, third party applications and other Internet based services.

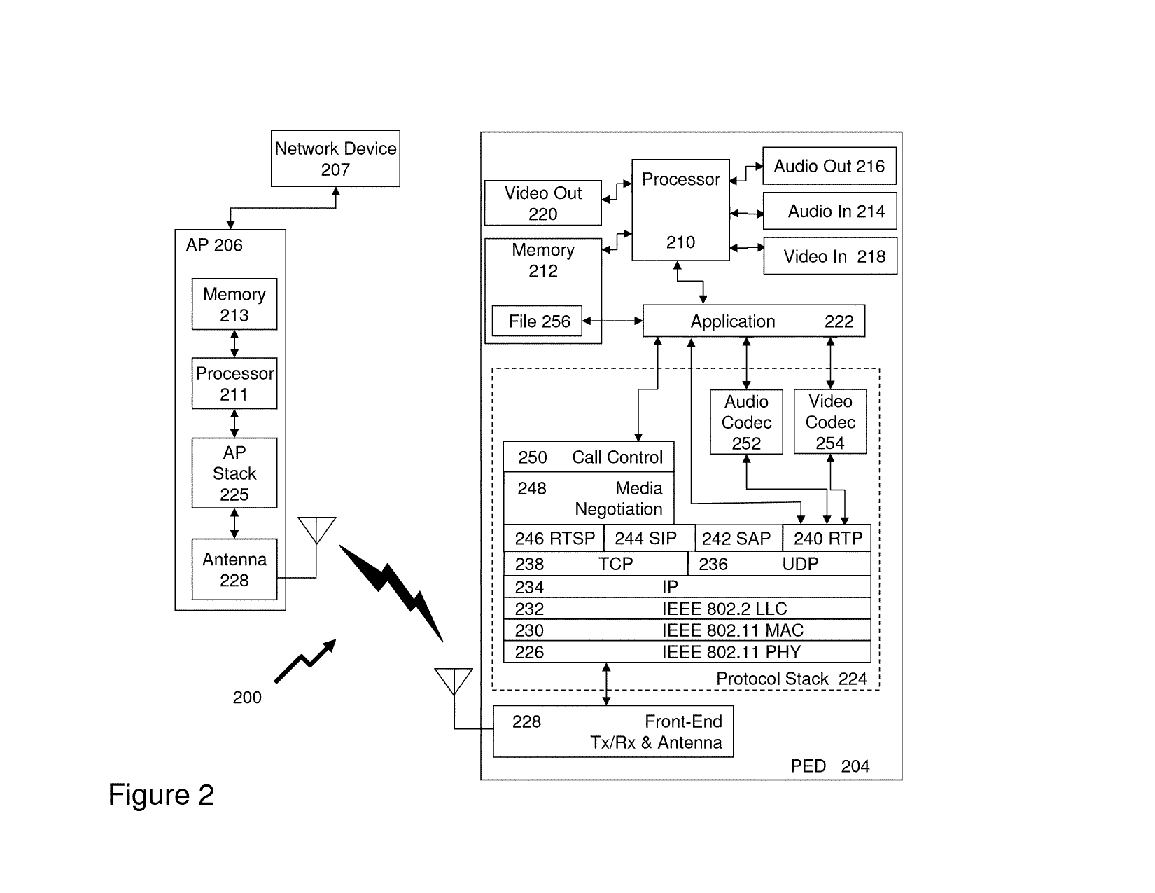

Referring to FIG. 2 there is depicted a portable electronic device (PED) 204, supporting communications and interactions according to embodiments of the invention. Also depicted within the PED 204 is the protocol architecture as part of a simplified functional diagram of a system 200 that includes a portable electronic device (PED) 204, such as a smartphone 155, an access point (AP) 206, such as first Wi-Fi AP 110, and one or more network devices 207, such as communication servers, streaming media servers, and routers for example such as first and second servers 175 and 185 respectively. Network devices 207 may be coupled to AP 206 via any combination of networks, wired, wireless and/or optical communication links such as discussed above in respect of FIG. 1. The PED 204 includes one or more processors 210 and a memory 212 coupled to processor(s) 210. AP 206 also includes one or more processors 211 and a memory 213 coupled to processor(s) 211. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

PED 204 may include an audio input element 214, for example a microphone, and an audio output element 216, for example, a speaker, coupled to any of processors 210. PED 204 may include a video input element 218, for example, a video camera, and a video output element 220, for example an LCD display, coupled to any of processors 210. PED 204 includes one or more applications 222 that are typically stored in memory 212 and are executable by any combination of processors 210. PED 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the PED 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module.

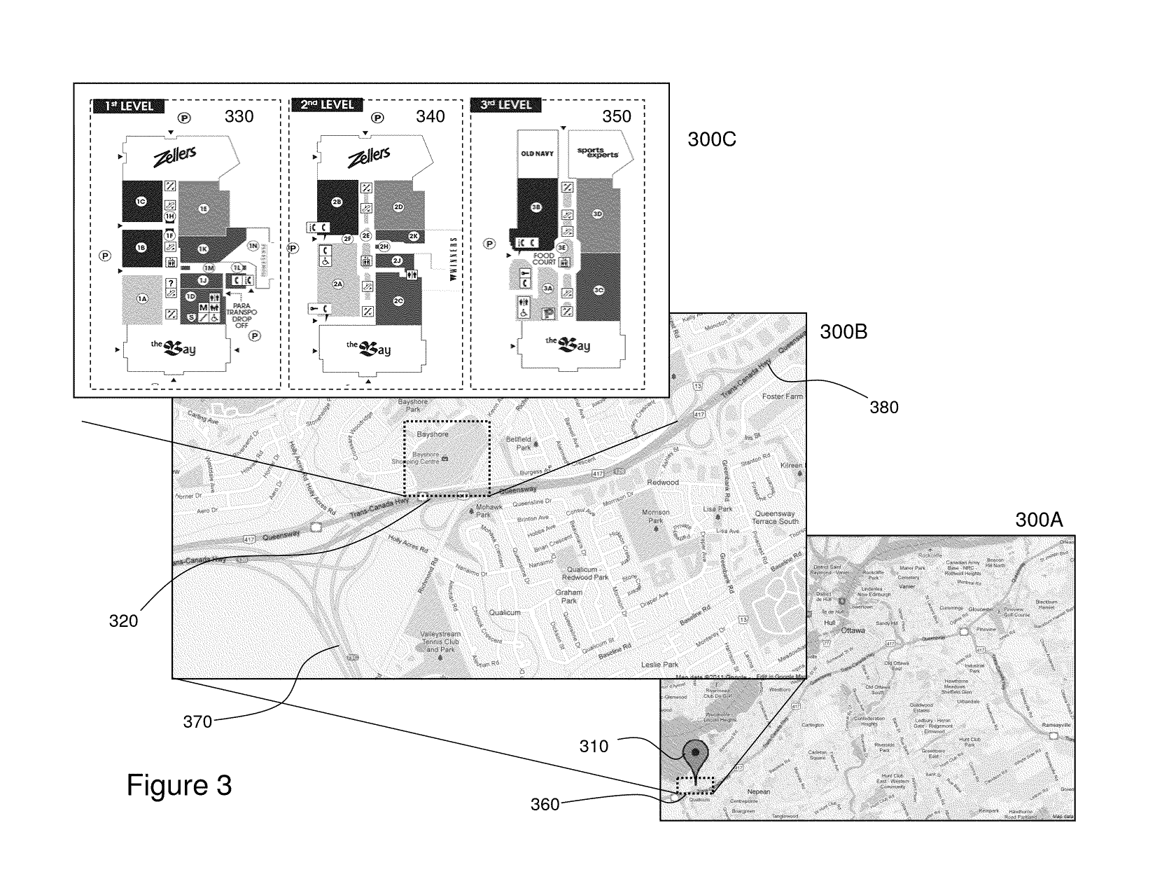

Now referring to FIG. 3 there is depicted a shopping centre comprising first to third levels 330 through 350 respectively in schematic map 300C which is situated in region 320 of first map 300B depicting an area of Ottawa, Ontario, Canada identified within second region 360 of second map 300A and marked by map marker 310. As evident from first map 300B the shopping centre, “Bayshore Shopping Centre” is located close to two highways, these being “Trans-Canada Highway” 380, known locally as the “Queensway” and being Highway 417″, and “Highway 416” 370 which goes from Ottawa south to join “Highway 401” which links Toronto and Montreal and runs along the Canadian side of the St Lawrence river with multiple crossing points to upper New York state in the United States. Accordingly it would be evident that the “Bayshore Shopping Centre” may be accessed from a substantially large area around Ottawa with relative ease in addition to providing a large local shopping centre for residents within the immediate and local neighbourhoods. Table 1 below lists typical distances and travel times from towns in Canada and the United States wherein the “Bayshore Shopping Centre” either represents a significantly larger shopping centre to those within the towns themselves or a different cross-section of retailers to those within the towns, even without considering benefits of exchange rates etc. (Note: the times/distances are as returned from Google with the defaults)

TABLE 1
Distances and Travel Times to “Bayshore Shopping Centre”

| United States | | | Canada | | |
|---|---|---|---|---|---|
| | Distance | Time | | Distance | Time |
| Town | (miles/km) | (hr:min) | Town | (miles/km) | (hr/min) |
| Syracuse | 186/300 | 3:12 | Kingston, ON | 114/184 | 2:12 |
| Watertown | 118/190 | 2:11 | Gatineau, QC | 17/28 | 0:28 |
| Massena | 84/136 | 1:38 | Pembroke | 84/135 | 1:55 |
| Rochester | 247/398 | 4:33 | North Bay | 215/347 | 4:55 |

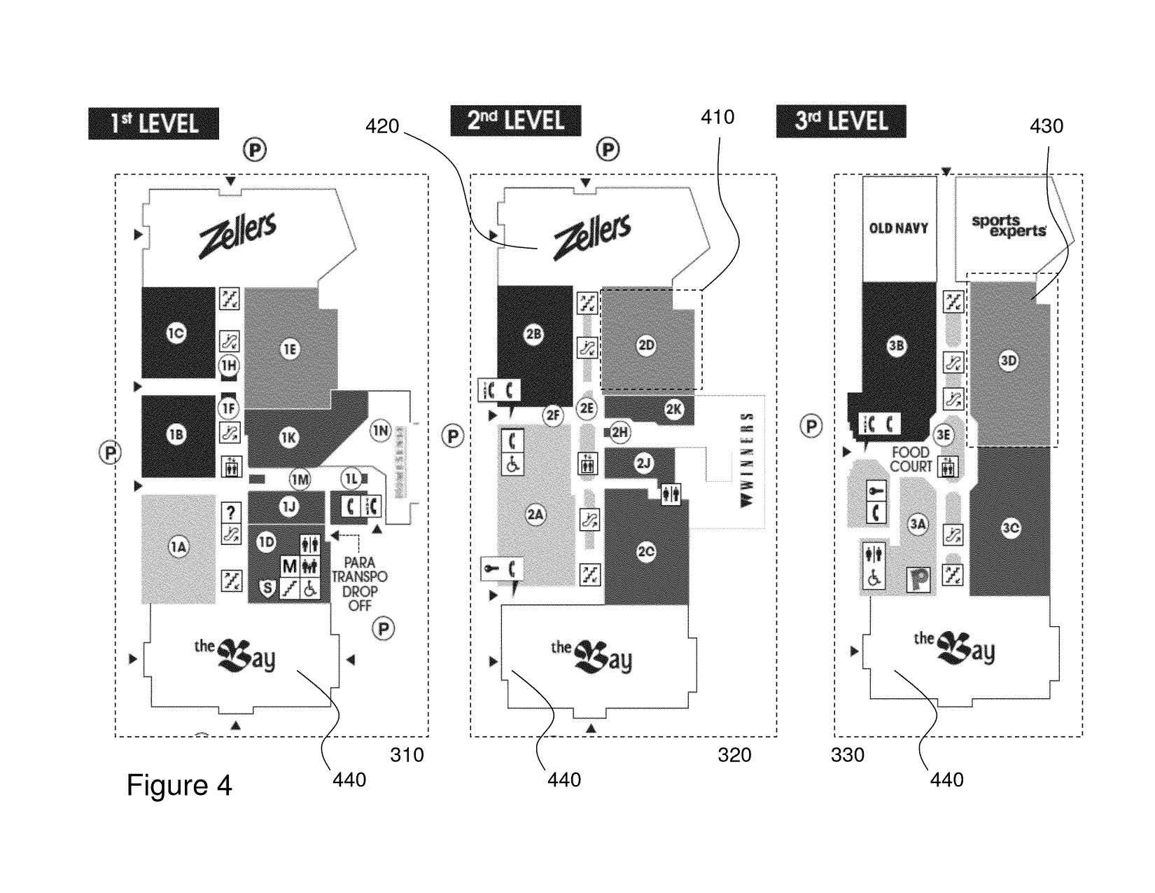

Referring to FIG. 4 the first to third floors 310 to 330 of “Bayshore Shopping Centre” are depicted again depicts schematic maps of the shopping centre in FIG. 3 relating to an environment for communications and interactions according to embodiments of the invention. The shopping centre is broken into a plurality of regions such as first region 410 on the second floor 320 and second region 430 on the third floor 330 which comprise multiple retailers of varying physical size and category. As presented below in Table 2 these regions can vary in size and number of stores such that, excluding the anchors of all forms, there are 53, 42, and 34 retailers on each of the first to third floors 310 to 330 respectively giving 129 retailers plus 6 anchors. The shopping centre is anchored, i.e. has a large retailer acting as a draw for customers, by main anchor 440, being “the Bay” which is present on first to third floors 310 to 330 respectively of the shopping centre, and secondary anchors including “Zellers” 420 who are present on the first to second floors 310 and 320 respectively. For the customer “Bayshore Shopping Centre” offers 24 retailers that offer women's clothing alone as are listed below in Table 3.

TABLE 2
Shops per Section of Mall

| Section | Qty | Section | Qty | Section | Qty |
|---|---|---|---|---|---|
| 1A | 5 | 2A | 9 | 3A | 9 |
| 1B | 11 | 2B | 10 | 3B | 10 |
| 1C | 9 | 2C | 9 | 3C | 9 |
| 1D | 3 | 2D | 6 | 3D | 5 |
| 1E | 6 | 2E | 1 | 3E | 1 |
| 1F | 3 | 2F | 1 | | |
| 1G | 1 | 2H | 1 | | |
| 1H | 1 | 2J | 3 | | |
| 1J | 8 | 2K | 2 | | |
| 1K | 4 | | | | |
| 1M | 1 | | | | |
| 1N | 1 | | | | |
| Total | 53 | | 42 | | 34 |

| | | | | | | |
|---|---|---|---|---|---|---|
| Anchor | the Bay | 1-3 | Zellers | 1-2 | Home Sense | 1 |
| Stores | Sports Chek | 1 | Old Navy | 1 | Winners | 2 |

TABLE 3
Women's Style Retailers in Bayshore Shopping Centre

| | | | |
|---|---|---|---|
| 2D Aritzia | 2A Eddie Bauer | 3 Old Navy | 2C Toxik |
| 1D Banana | 3C Garage | 2D Reitmans | 3C Tristan |
| Republic | | | |
| 1E Bluenotes | 3A Jacob | 3B Ricki's | 1A 1850 |
| 1E Boathouse | 3B Jean Machine | 3D Roots | 3D Urban Trade |
| 2J Cleo | 1D Joshua Perets | 3C Shepherd's | 2B Warren's |
| 2C Coats Co. | 3C Le Chateau | 1A Sirens | 2C West |
| 2C Danier | 3D La Senza | 2D Smart Set | 2 Winners |
| 3C Dynamite | 2B Northern | 2 The Bay | 1-2 Zellers |
| | Reflections | | |

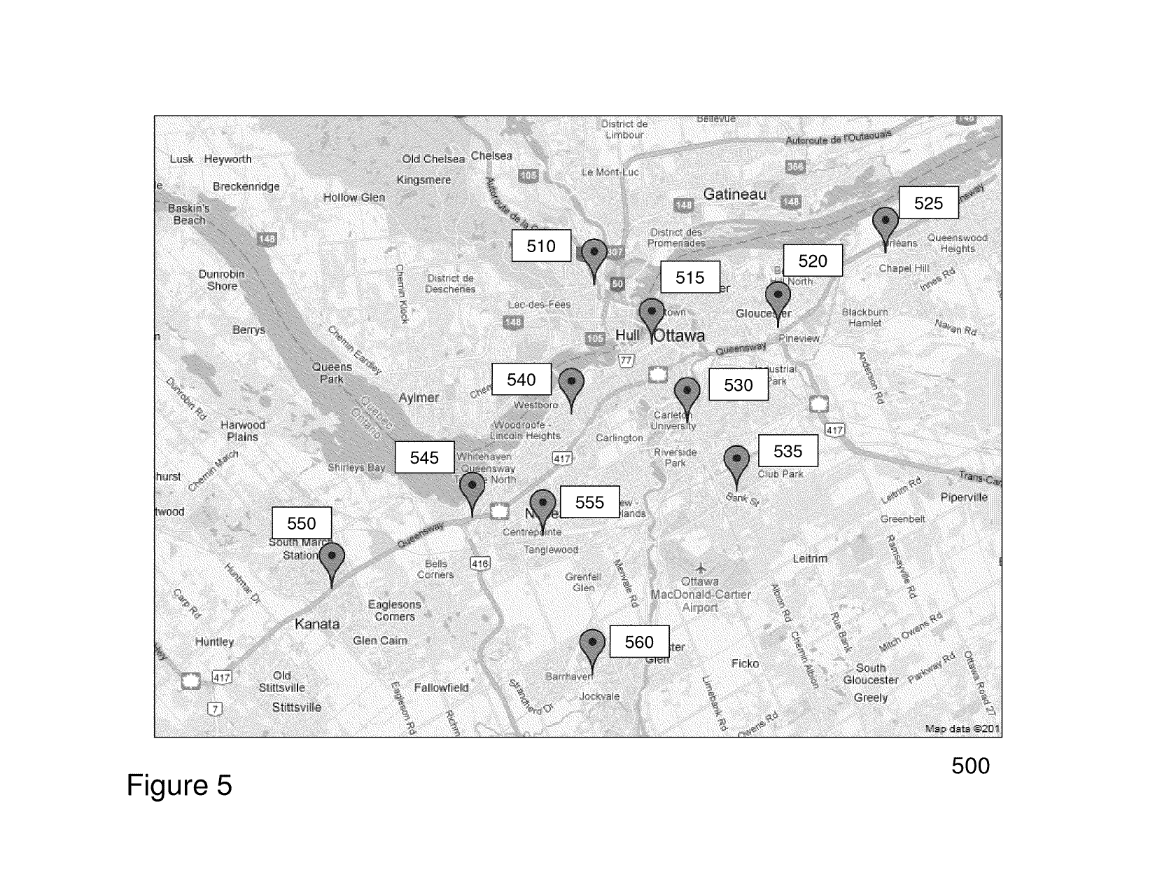

Accordingly an individual seeking to purchase an item of women's clothing is presented with 24 stores distributed within the 165 stores overall across three floors of the “Bayshore Shopping Centre.” This is exacerbated further as depicted in FIG. 5 by map 500 outlining other large shopping centres within Ottawa together with “Bayshore Shopping Centre” 545. These other shopping centres being “Les Galeries de Hull” 510, “Rideau Centre” 515, “Gloucester Centre” 520, “Place d'Orleans” 525, “Billings Bridge” 530, “South Keys” 535, “Carlingwood” 540, “Kanata Centrum” 550, “College Square” 555 and “Barrhaven” 560. Additionally, many neighbourhoods within the city including Westboro, Glebe, and Centretown comprise neighbourhood based centres of shopping which is boutique and non-retail chain based.

Accordingly the consumer is faced with a very large number of options and in the instances of the plurality of shopping centres repetitions of outlets of a retail chain such as “The Gap” for example and their associated stores “Gap Kids” although the breadth of inventory at these stores may vary substantially. In other instances, for example the LCBO (Liquor Control Board of Ontario) adjusts the inventory of its liquor outlets in dependence upon the demographics of the neighbourhoods that the stores are in. Accordingly, the apparently simple task of going and buying a white blouse and a particular Barefoot™ wine can become a major activity for a woman, couple or family absorbing considerable time and leading to frustration and even anger.

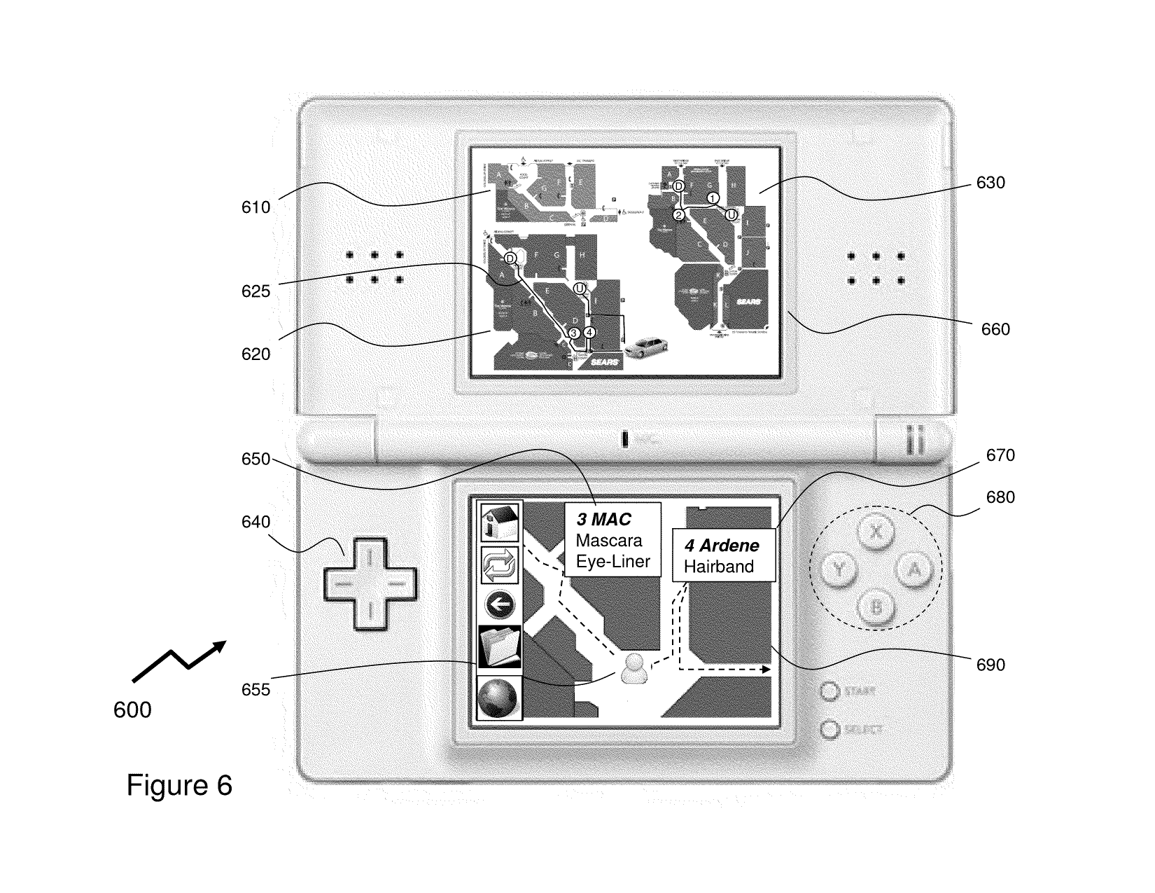

Referring to FIG. 6 there are depicted exemplary screen images presented to a user of an application according to an embodiment of the invention upon their gaming console 600. Within upper screen 660 the user is presented with an overall sequence of first to third maps 610 to 630 respectively of a shopping centre, actually “Rideau Centre” 515. Within these the software application in execution upon the gaming console 600 has displayed a route 625 based upon the customers shopping list, their selection of the shopping centre, and identification of the customer's entry point into the shopping centre. Also displayed upon the route 625 are markers identifying how many retail outlets the customer will need to visit to complete purchasing of the items on their shopping list. Lower screen 690 presents an enlarged image of the shopping centre based upon the customers actual location as determined by means of a technique such as GPS or triangulation for example. Displayed upon the enlarged image is a customer marker 655 denoting the customer's location as well as retail outlet icons 630 and 670 which reflect the third and fourth locations, being “MAC” where the customer has indicated that mascara and eye-liner are to be purchased and “Ardene” where a hairband is to be purchased.

The gaming console 600 provides the customer with first and second controls 640 and 680 which allow the customer to navigate through the software application as required during their visit to the shopping centre. It would be evident to one skilled in the art that the software application according to embodiments of the invention may automatically provide the maps upon the lower and upper screen 690 and 660 respectively based upon detecting that the customer has arrived at the shopping centre. Such automatic functionality may extend to detecting the entry point of the customer, communicating to a remote server to retrieve the customers shopping list and map. Where the shopping centre has multiple levels, such as depicted through first to third maps 610 through 630 respectively in upper screen 660 the route 625 may also depict where the customer should move between the levels of the shopping centre. Based upon the options of the customer, as will be discussed below in respect of other Figures the software application may direct the customer to multiple level changes if such a route optimizes better to the customers preferences rather than simply directing them level by level.

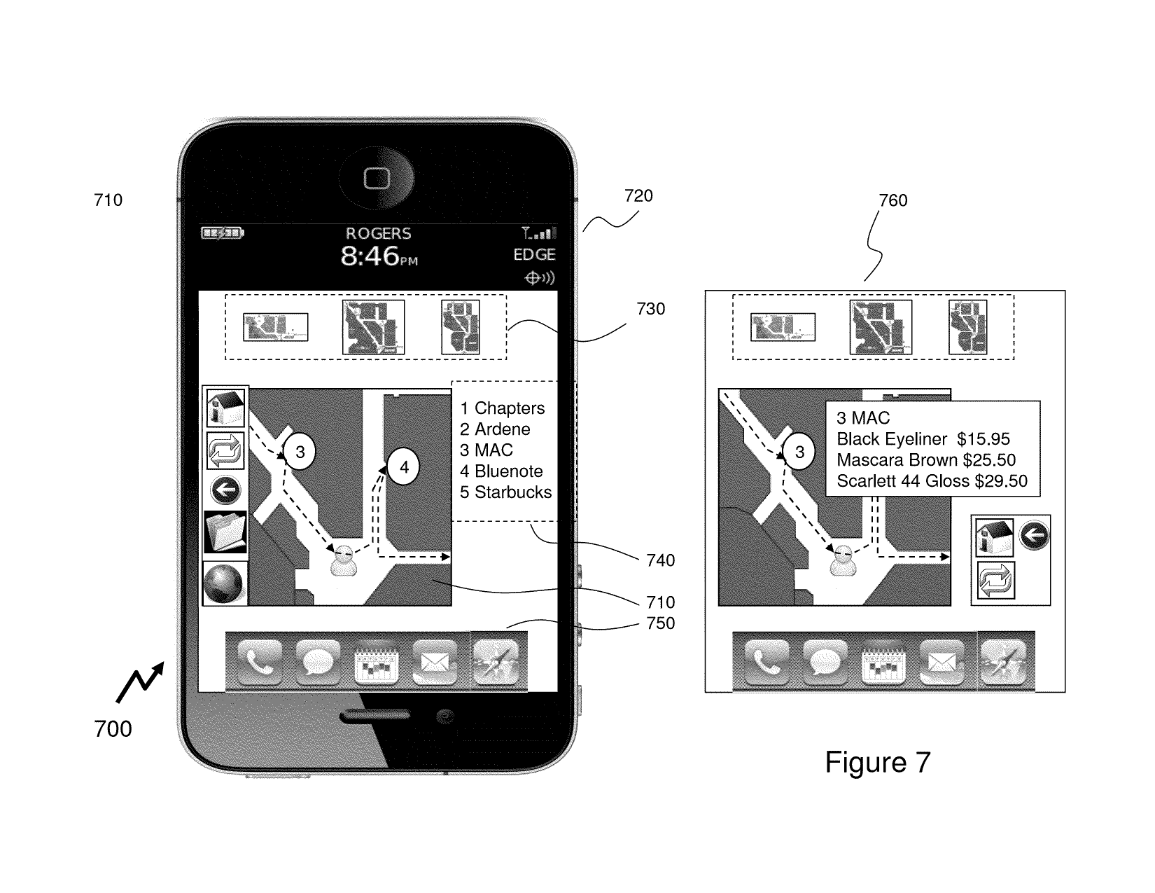

Referring to FIG. 7 there is depicted an exemplary sample screen 700 on a smartphone 720 presenting a single screen display as opposed to the dual screen display of the gaming console 660. Accordingly, a map bar 730 in the upper portion of the display provides user selectable map icons that will bring up more information regarding these maps which in this instance are the levels of the shopping centre. Such information may for example be downloaded to the smartphone 720 from the software system itself or retrieved from the web servers of the shopping centre. Such information may arise from user driven queries such as “Nearest washroom” or “Nearest ATM” for example. A detail map 710 is presented to the user with their location and suggested route through the shopping centre to visit each retailer within the shopping centre providing an item of the customers shopping list.

When the customer comes within a predetermined range from a retail outlet on their list the display reconfigures to second display the list of items the customer has indicated that they wish to procure. These may be presented as a list with descriptions and pricing, pictorially, or in combination with a map of the retail outlet or combinations thereof.

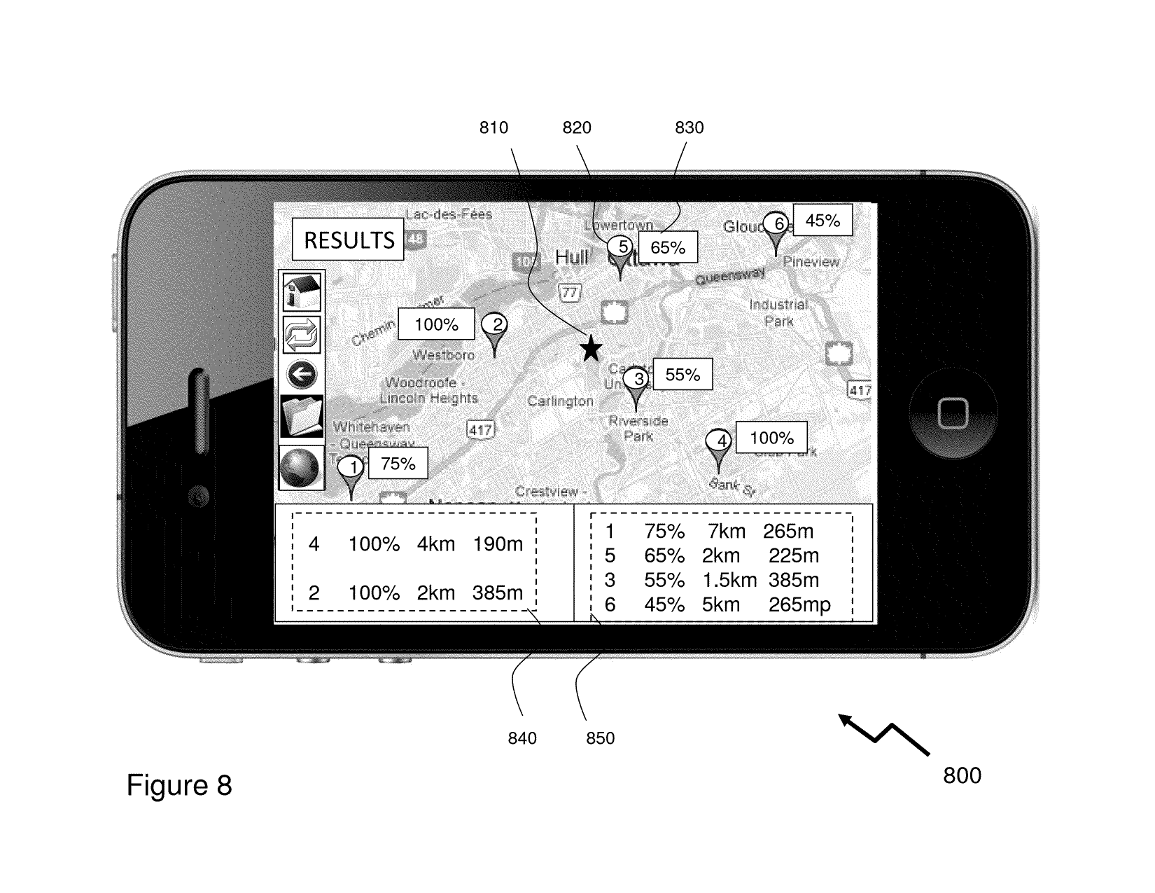

Now referring to FIG. 8 there is depicted an exemplary sample screen image 800 presented to a user of an application according to an embodiment of the invention wherein the user has performed a search with the software application, the software system or a combination thereof. The user has previously entered a list of items that they wish to procure wherein the screen image 800 provides a map displaying returned shopping locations, for example “downtown” 820 together with search result value 830, in this case 65%. Also displayed is user location 810. At the lower portion of the screen image 800 the results are tabulated with top hits 840 and secondary hits 850 respectively. Top hits 840 shows that Location 4 and Location 2 both have result values of 100%, implying that all items on the users list can be obtained, but that Location 4 is 4 kilometers away and requires the user to walk 190 meters whereas Location 2 is closer at 2 kilometers but requires the user to walk 385 meters. If the user has difficulty walking then Location 4 despite its increased distance represents a better option for the user.

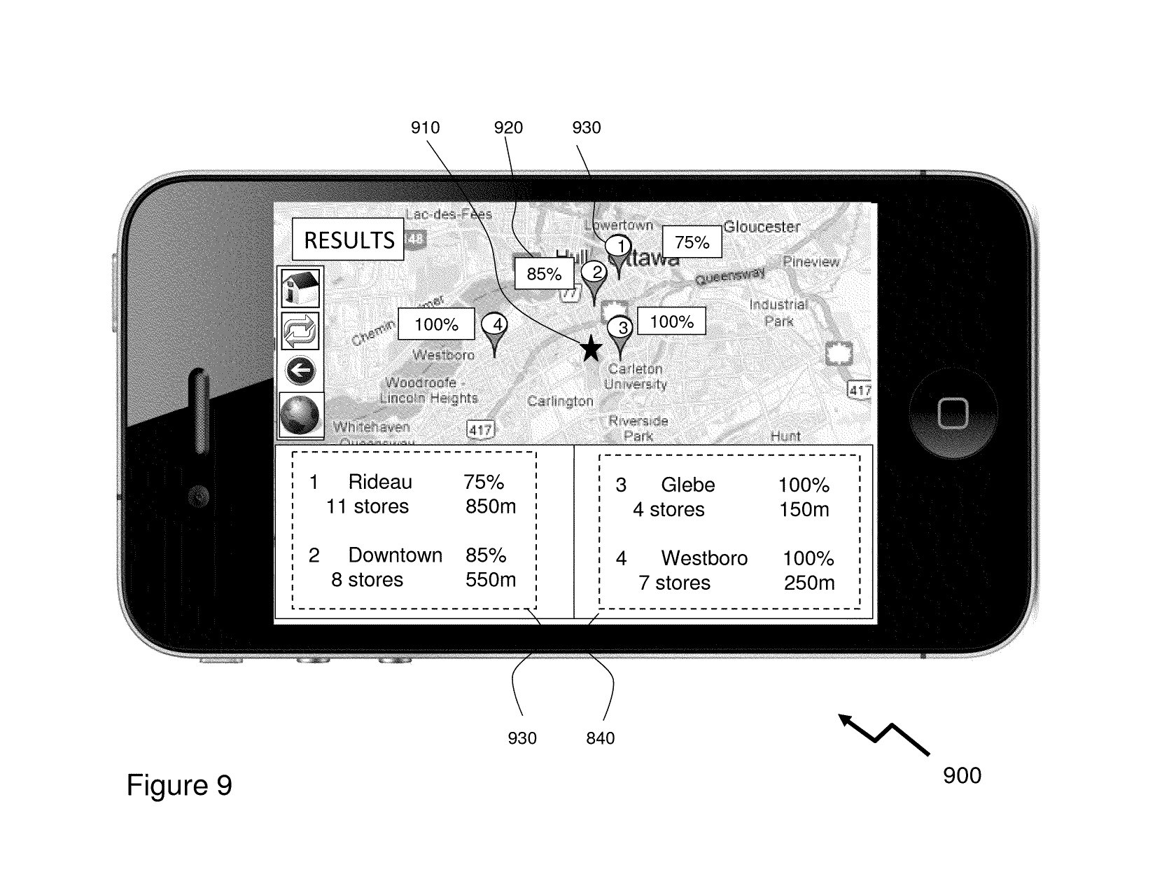

It would be evident to one skilled in the art that the user may select multiple criteria for generating the search results including but not limited to availability of the products/services that the user wants, distance from user location, distance the user must travel at the shopping centre to acquire the items, retail outlet preferences, number of retail outlets, and cost. For example FIG. 9 depicts an exemplary sample screen image 900 presented to a user of an application according to an embodiment of the invention wherein results are displayed to the user wherein the returned results contain a match for a store the user wishes to select an item or items from but no other filtering has been applied. Accordingly the user is presented with four returned locations, numbered 1 to 4 with varying overall matches between 75% and 100%, required numbers of retail outlets to visit varying between 4 and 11, and travel distances within each location between 150 m and 850 m. As such the user may elect to visit the “Glebe” location, location 3, which has a 100% match, a low travel distance of 150 m, and only 4 stores to visit. Upon the screen image 900 each location is shown by a marker 930 with result 920 in conjunction with the user location 910.

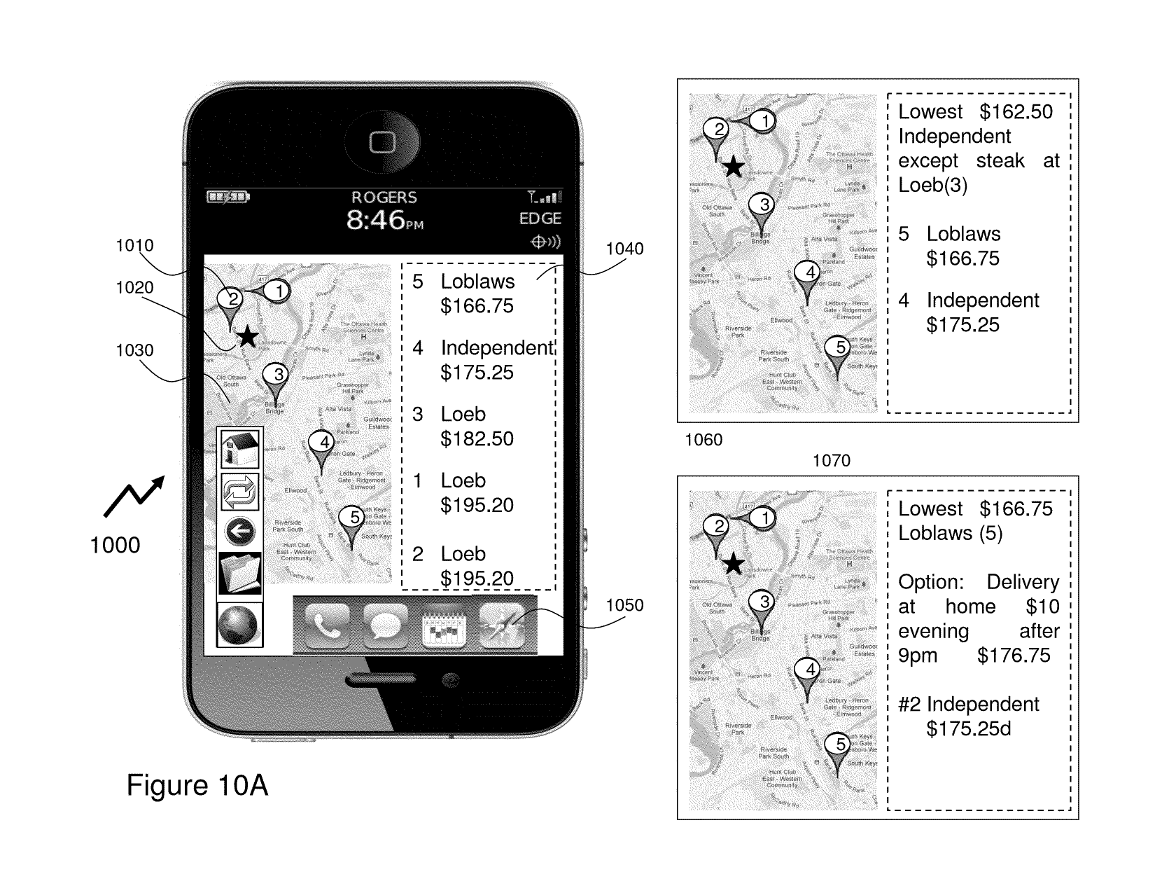

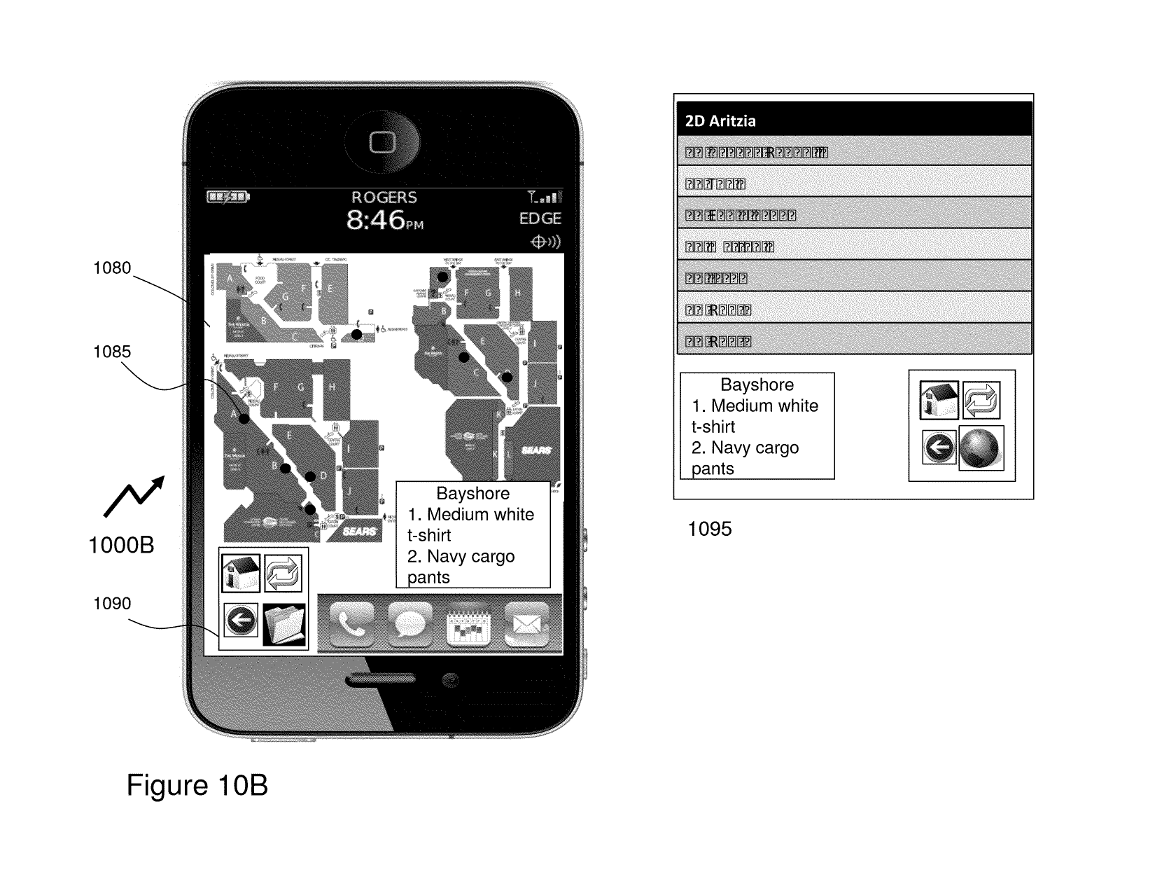

Referring to FIG. 10A there is depicted an exemplary sample screen image 1000 presented to a user of an application according to an embodiment of the invention wherein the search filter applied by the user is based upon cost of acquiring all items on the users shopping list. As such the user is presented with a map 1030 showing shopping locations 1010 in association with the user location 1020. Also presented is list 1040 denoting next to each shopping location a cost of purchasing the items at that location. Accordingly, location 5 is the lowest cost presenting the user with a cost of $166.75 although as is evident the location is further away from location 3 which is more expensive at $182.50. However, the user may be pressed for time and elects to choose location 3 aware of the increased cost but reduced time.

By selecting another function within the software application the user is presented with a first alternative screen 1060 wherein the lowest cost is $162.50 if the user purchases all items at “Independent”, being location 4, except the steak which is cheapest at “Loeb” location 3. Similarly, another function selection presents second alternative screen wherein “Loblaws” location 2 is noted as being the lowest cost for the user to purchase at for $166.75 but they may elect to have home delivery for an additional $10 after 9 pm making that particular option only slightly more expensive than the closest location, “#2 Independent.” Accordingly it would be evident to one skilled in the art that the user having entered a shopping list and preferences may vary the preferences through selections within the software application such that different results are presented to them. In this manner the user can establish a solution to the required procurement of the items on the list that meets their particular needs at that time which may be different the next time they wish to purchase items on a shopping list.

It would be evident that the shopping list may be a single item, multiple items or a very large number of items. It would also be apparent that the location of the user within the analysis may be their current location, wherein they wish to procure now, or it may selected to represent a point in time when they do wish to make the purchases rather than now such as for example after work or after dropping a family member at an activity.

Now referring to FIG. 10B there is depicted a portable electronic device 1000B displaying a search result according to an embodiment of the invention wherein the user has searched for “Bayshore Shopping Centre” and for a store supplying both “white t-shirt” and “navy cargo pants” which has returned 8 search results from the 24 woman's clothing stores in the shopping centre. These are displayed in this instance on a map 1080 of the shopping centre as markers 1085 together with application icons 1090. Application icons 1090 including “home”, “swap screen”, “back”, and “list.” If the user selects the list icon then the screen swaps to screen 1095 wherein the stores matching the user's search requirements are listed. The list may be weighted by one or more additional factors or preferences including for example, price, quantity of each product in stock at that outlet, and user preferences.

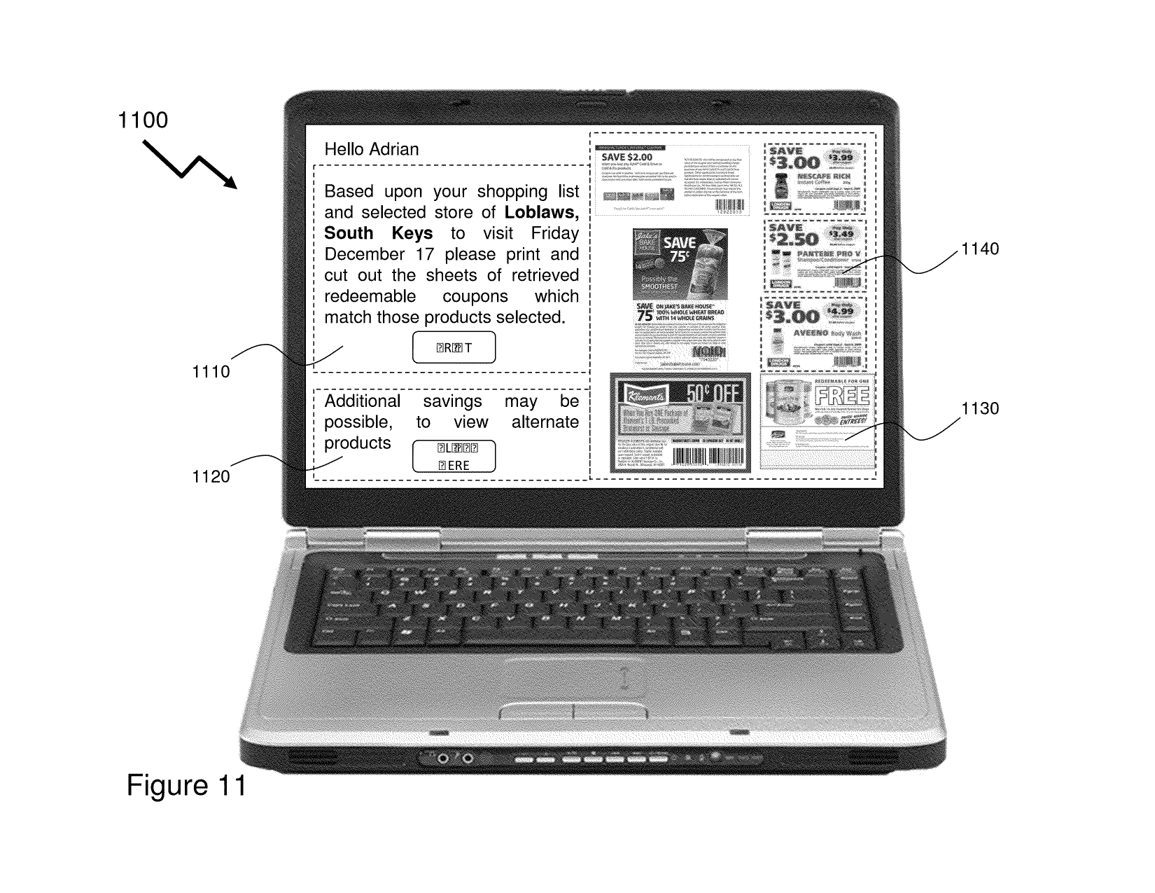

It is also known within the prior art for shopping centres, retail outlets, and manufacturers to offer incentives to potential customers through discounts which were traditionally presented to the user as coupons in distributed “flyers.” Today these are augmented with the availability of online coupons which may be accessed by all users or only those who have registered with a particular outlet, shopping centre or manufacturer. It is also not uncommon for the discounts to vary between stores within the same city. Referring to FIG. 11 there is depicted an exemplary sample screen 1100 presented to a user of a software application according to an embodiment of the invention. The user having entered their shopping list and selected their desired store is presented with a first message 1110 notifying them that coupons for the day they intend to visit the store are available and that these, or a subset of these, may be displayed in the window adjacent the first message 1110 as represented by first and second coupons 1130 and 1140 respectively. The user is also presented with second message 1120 which notifies the user that other alternative products provided by the selected retailer or retailers may further reduce their overall expenditure.

It would be evident that in another embodiment of the invention the software application and/or software system may include such discounts/coupons in the calculation of the overall cost if selected by the user. In some embodiments of the invention the user may be required to print the coupons for redemption at the retailer whereas in others these may be electronically stored on a portable electronic device and applied through a system such as Near-Field Communications allowing the retailer sales system to be notified of the coupons at the point the user checks out and wishes to pay for the selected items.

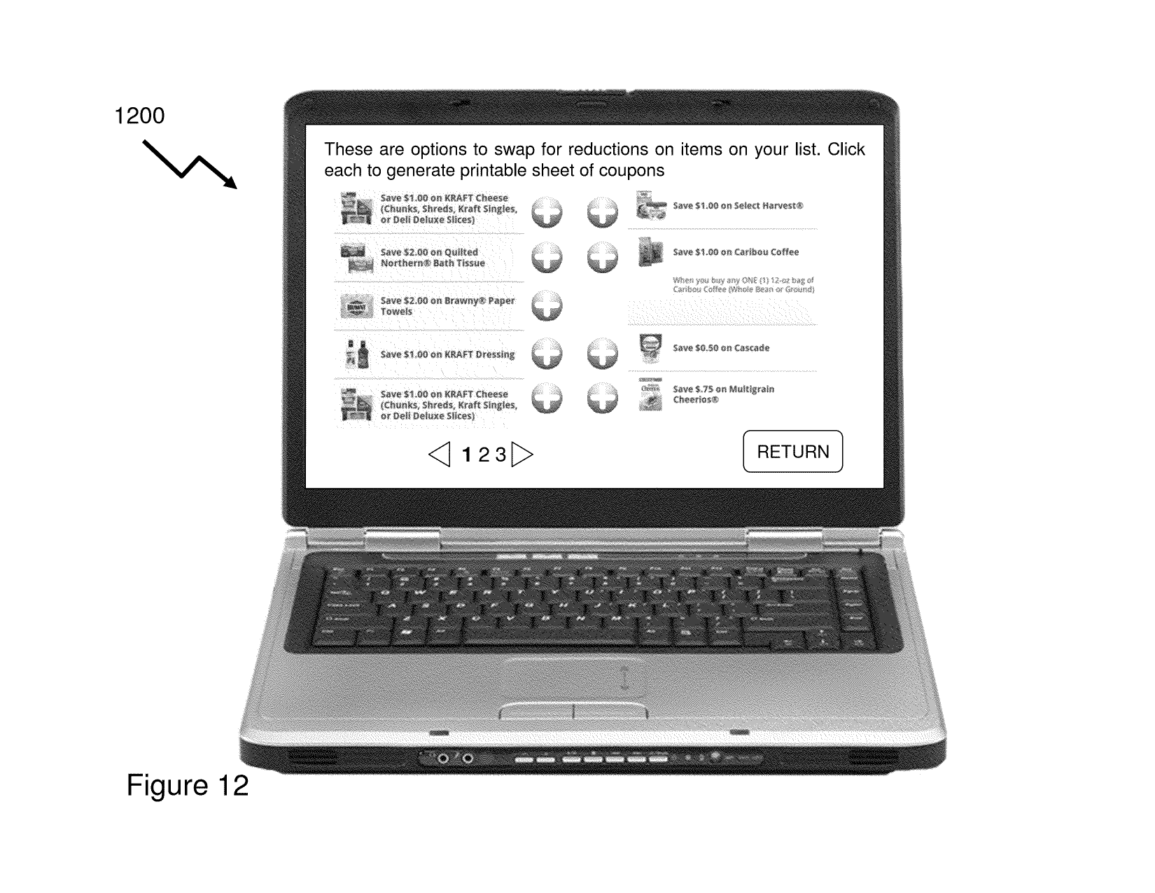

Now referring to FIG. 12 there is depicts an exemplary sample screen 1200 presented to a user of a software application according to an embodiment of the invention wherein the software application and/or software system present the user with options to reduce their expenditure. As such a series of items are presented to the user with information relating to the product offering the reduction as well as other information such as reduction possible etc. Adjacent to each the user may select the substitution to their shopping list. Upon selecting an alternate the shopping list is updated and according to options selected by the client the overall analysis is repeated, a subset of it is repeated or no re-analysis is performed. According to another embodiment of the invention these substitutions are displayed to the user when they are purchasing the items on their list so that the most current cost savings are presented to the customer.

It would also be evident that substitutions may only be presented to the user wherein they are located proximate the original selection such that substitutions do not result in substantial amendments to the search results by making the user visit sections of the store they would not have done previously for example or substantially increasing their distance travelled where this factor is identified as high priority to the user.

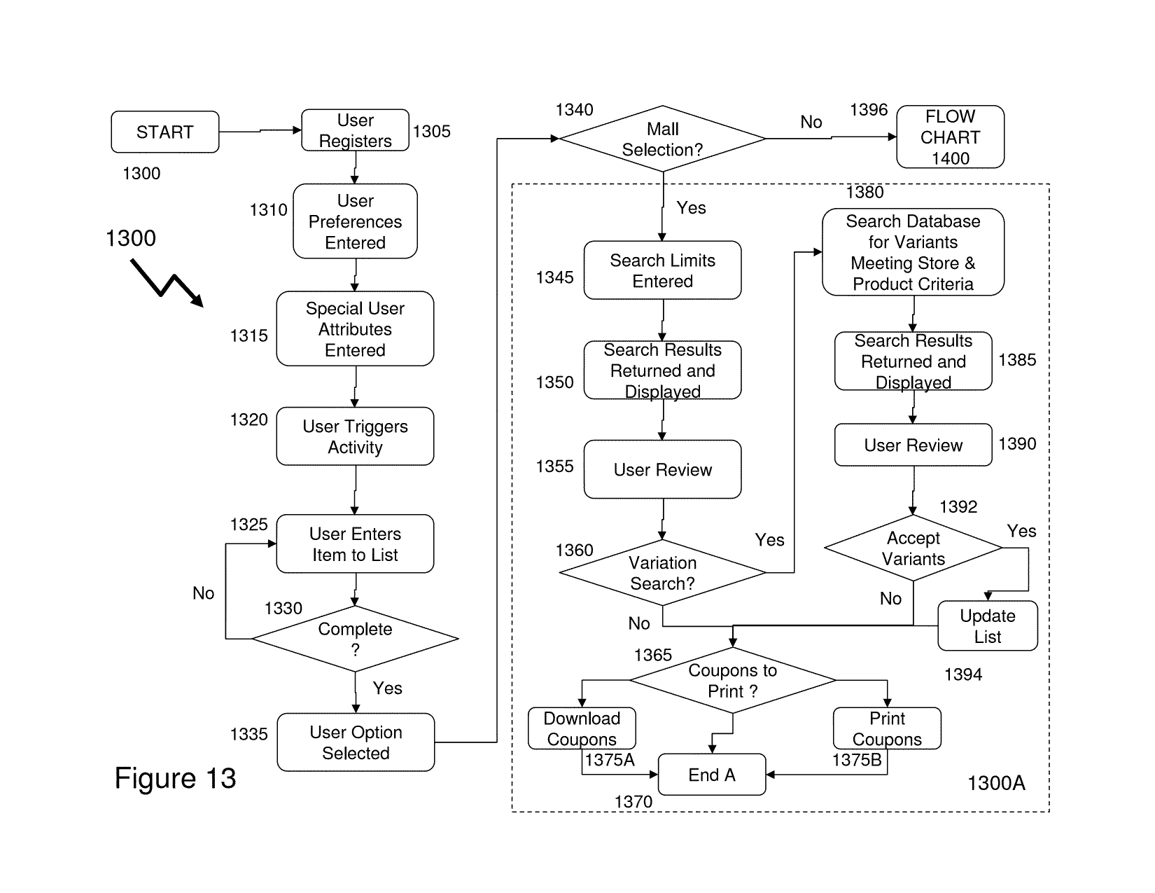

Referring to FIG. 13 there is depicted an exemplary process flow 1300 relating to an application according to an embodiment of the invention. As depicted the process begins at step 1300 where the process starts and proceeds to step 1305 wherein the user registers with the software application and software system before in step 1310 the user enters their preferences which may include, but not be limited to, retailer preferences, retailers to avoid, shopping centre preferences, travel limits, walking limits, and time of day. Next in step 1315 the user enters any special attributes that relate to the user. Next in step 1320 the user triggers an activity wherein the flow proceeds to step 1325 and the user enters an item to their list which may be via direct text entry, selection from one or more drop-down lists, or selection from a previously generated list. For example, the user may have a regular shopping list of basic items to which they add.

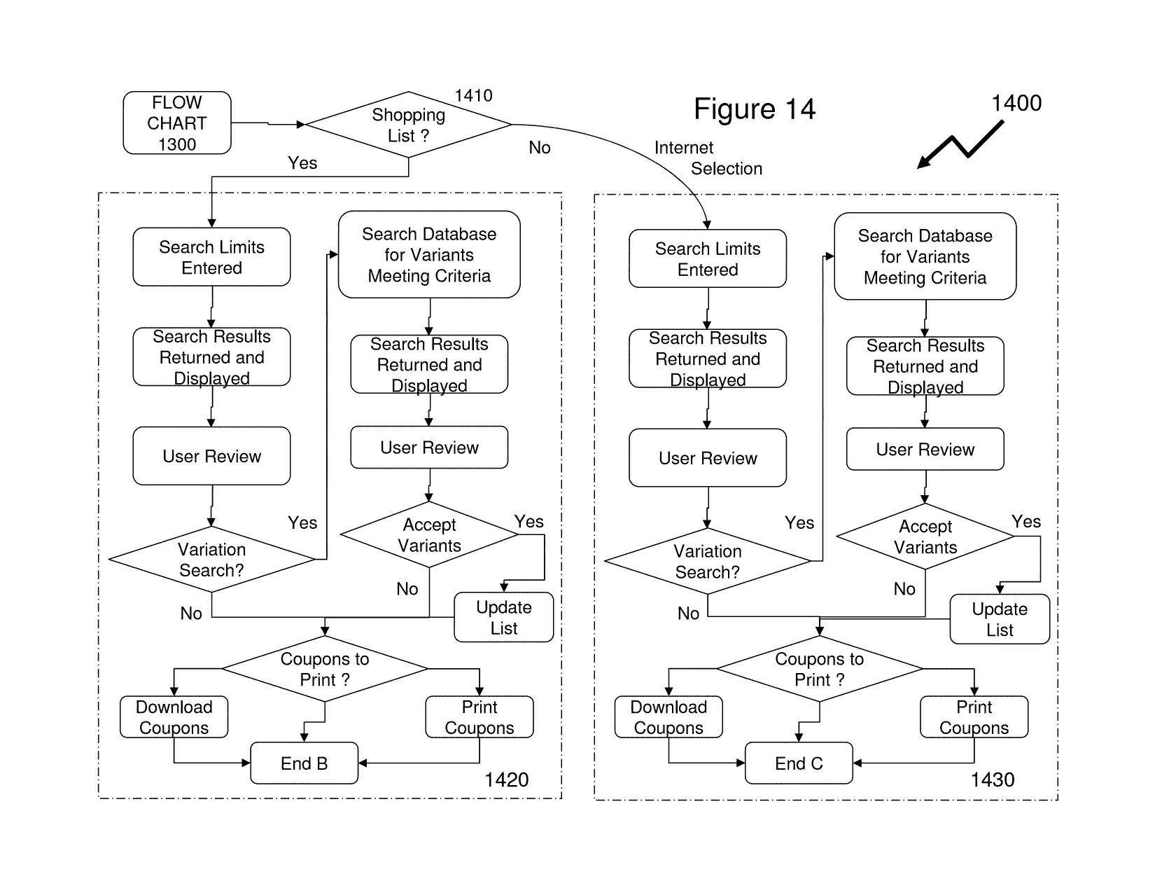

Next in step 1330 the process determines whether the user has completed their list. If no, the process loops back to step 1325 otherwise the process proceeds to step 1335 wherein the user makes their selection of whether they wish to select based upon a shopping centre, retailer, or Internet based activity. In step 1340 the process determines the selection made by the user wherein if the user has selected shopping centre then the process proceeds to step 1345 otherwise the process proceeds to step 1396 and executes second process flow 1400 as described below in respect of FIG. 14. In step 1345 the search limits are entered by the user resulting in step 1350 with the software application and/or software system providing returned results which are rendered to the user. In step 1355 the user reviews the returned results and determines in step 1360 whether to perform a search for variants. If the determination in step 1360 is to perform a variant search the process proceeds to step 1380 otherwise it proceeds to step 1365. In step 1365 the software application and/or software system accesses one or more servers relating to the selected retailers within the shopping centre and correlates special offers and/or coupons from these with the items on the user's shopping list.to determine whether there are any special offers and/or coupons the user can redeem to reduce the cost of their shopping.

If the determination in step 1365 is that coupons exist to be printed then the process proceeds to step 1375B wherein the user prints the coupons and the process then proceeds to step 1370 and terminates. If the determination in step 1365 is that coupons exist to be download then the process proceeds to step 1375A wherein the user downloads the coupons and the process then proceeds to step 1370 and terminates. If there are no coupons the process proceeds directly from step 1365 to step 1370 and terminates. Accordingly it would be evident to one skilled in the art that the process flow described above in respect of FIG. 13 provides a user with a flexible means to enter a list of items and select a location to procure or view the items (browse).

In the event that the response at step 1360 is yes the process moves to step 1380 wherein the software system and/or software application search retailer and shopping centre databases for example to identify variants meeting store/retailer and product criteria wherein in step 1385 these results are returned and displayed to the user for review in process step 1390. In step 1392 the user determines whether to accept these variants wherein if yes the process moves to step 1394 wherein the list is updated and the process proceeds to step 1365 otherwise the process moves directly to step 1365.

As discussed above in respect of FIG. 13 where the determination of the process flow 1300 is other than selecting a mall the process proceeds to step 1396 and executes second flow 1400. This second flow 1400 is depicted in FIG. 14 and begins with the determination in step 1410 of whether the user wishes to proceed with a shopping list activity or Internet based activity. If the determination is that a shopping list activity is to be performed the process proceeds to first sub-flow 1420 otherwise the process proceeds to second sub-flow 1430. Each of first and second sub-flows 1420 and 1430 respectively are equivalent to steps 1345 through 1394 presented above in respect of FIG. 13 and identified as sub-flow 1300A in FIG. 13.

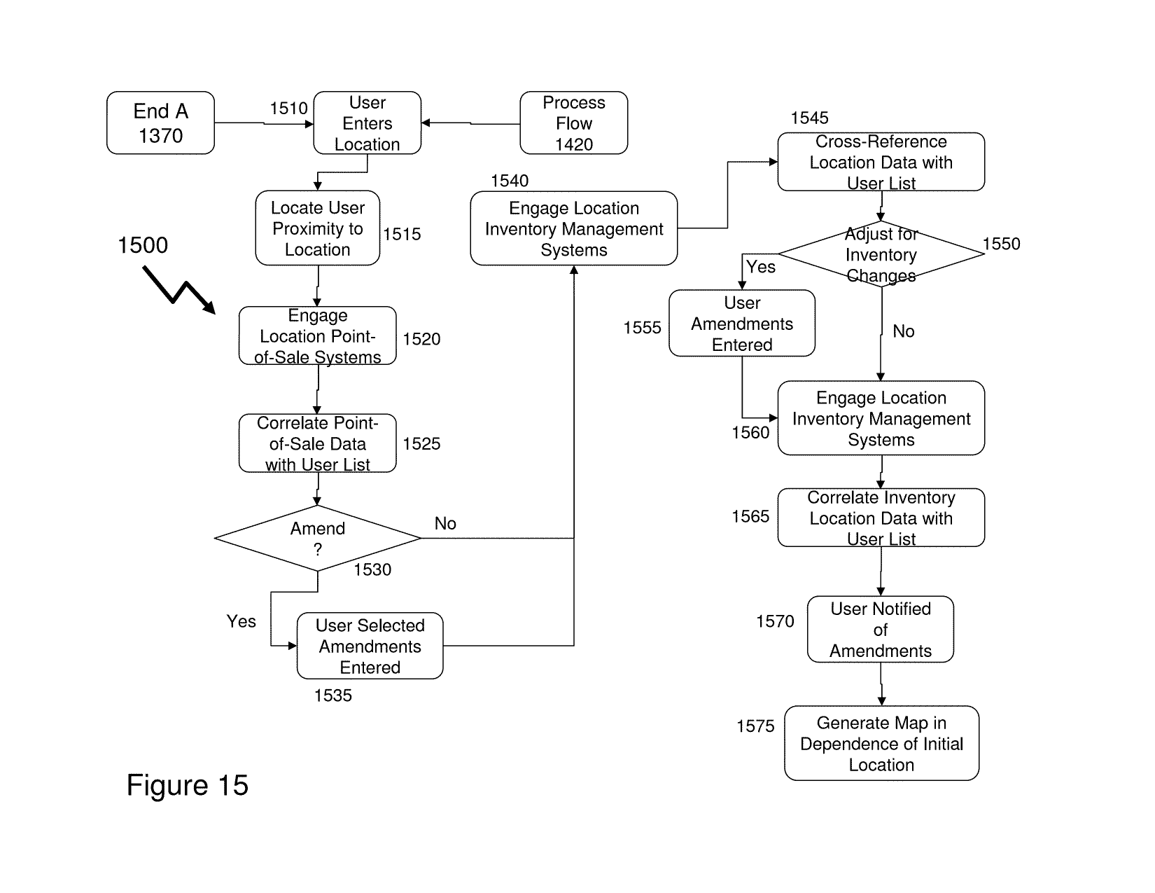

As described above in respect of process flow 1300 in FIG. 13 where the user selects the shopping mall option the process ends at step 1370 where the user has selected the shopping centre. Accordingly in FIG. 15 there is depicted an exemplary process flow relating to an application according to an embodiment of the invention wherein the user has now travelled to the location in step 1510. Step 1510 also being the next step after completion of first sub-flow 1420 in FIG. 14 where the user visits the shopping centre. From step 1510 the process proceeds to step 1515 wherein the software application establishes the user's proximity to the selected location and engages the point-of-sales data in step 1520 for the retailers identified within the active list of retailers and wares/services to retrieve data relating to these wares/services. In step 1525 this data is correlated to the list stored within the software application and/or software system for the user to determine whether any amendments are required to the retailers and/or wares/services. If there are no amendments the process proceeds to step 1540 otherwise the amendments accepted by the user are entered in step 1535 wherein the process proceeds to step 1540. Accordingly pricing adjustments relating to selected wares/services are notified to the user who may amend the list in dependence of these adjustments.

In step 1540 the software application and/or software system engages the inventory management systems of the retailers and in step 1545 cross-references the user list data with the inventory data retrieved for the retailers within the user list and presented to the user. In step 1550 the user identifies whether they wish to accept the adjustments in their list that arise from a lack of inventory wherein if they do the process moves to step 1555 and the list is updated before progressing to step 1560 which is directly accessed if the determination of accepting the changes is not to as they still wish to visit the store to see alternatives, establish a back-order etc. In step 1560 the retailer inventory management systems are again engaged by the software application and/or software system to establish the location data for the products on the user list. In step 1565 the location data is correlated to that within the user list and the user is notified of any amendments in step 1570 wherein the software application and/or software system thereby generates and renders a map in step 1575 in dependence upon the user's location based upon the amendments to the products/services. It would be evident that step 1570 may be modified to allow the user to accept or reject the amendments as they may wish to still choose a product related to the ones that are not in the retailer's inventory and there is a reasonable expectation that these alternative products are close to the location of the original product that is no longer in stock. Examples of generation and rendering of maps relating to a location are described above in respect of FIGS. 6 and 7.

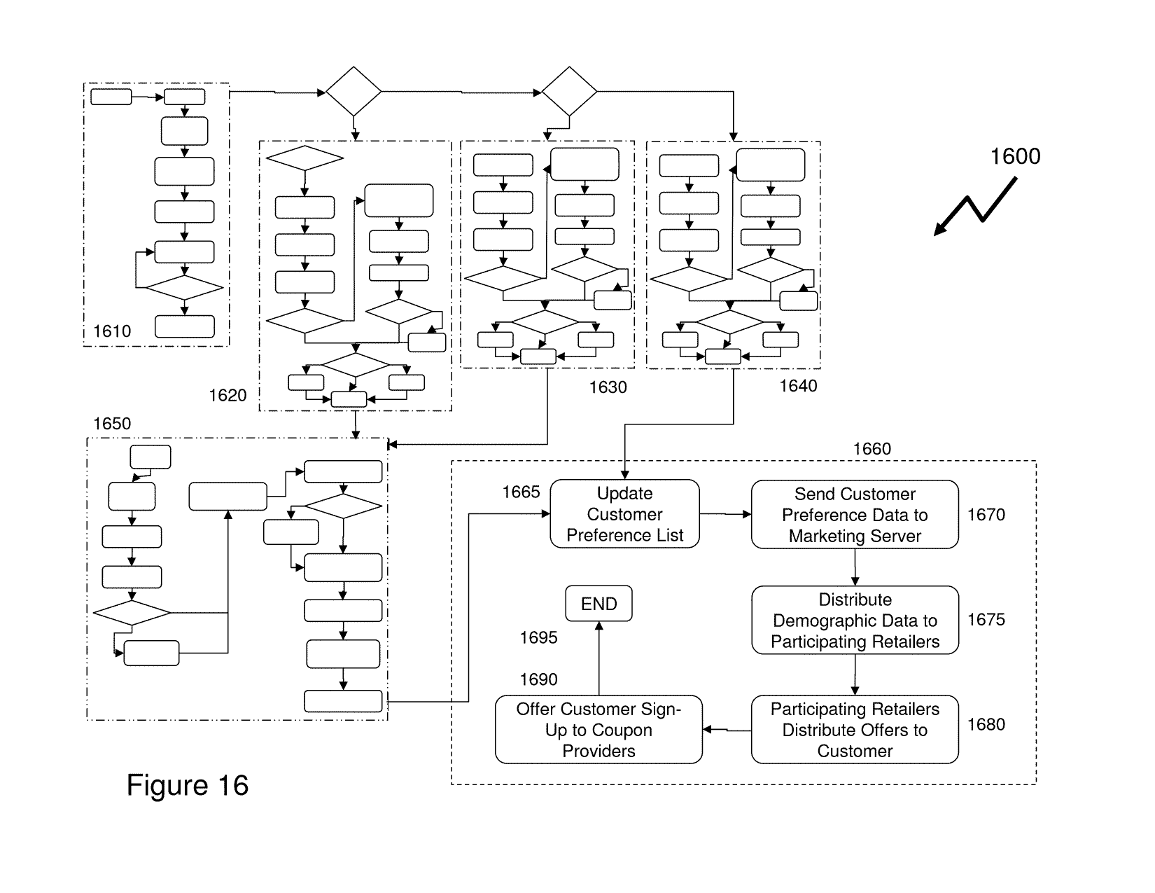

Now referring to FIG. 16 there is depicted an exemplary process flow 1600 relating to an application according to an embodiment of the invention. As depicted process flow 1600 comprises first to sixth sub-flows 1610 through 1660 respectively wherein:
first process flow 1610 may for example be represented by steps 1300 through 1335 of process flow 1300 in FIG. 13;
second process flow 1620 may for example be represented by steps 1345 through 1394 of process flow 1300 in FIG. 13;
third process flow 1630 may for example be represented by first sub-flow 1420 in process flow 1400 in FIG. 14;
fourth process flow 1640 may for example be represented by second sub-flow 1430 in process flow 1400 in FIG. 14;
fifth process flow 1650 may for example be represented by process flow 1500 in FIG. 15.

Sixth process flow 1660 begins with step 1665 wherein the customer preference list is updated based upon the user's decisions and entries in the first to fifth sub-flows 1610 through 1650 respectively. The process step 1665 being accessible upon progression of the user's actions within first to fifth sub-flows 1610 through 1650 respectively such that they progress to “End C” in fourth sub-flow 1640 or step 1575 in process flow 1500. From step 1665 the process moves to 1670 wherein the customer preference data established in dependence upon their selections through the process flows and selections on their shopping list is transmitted to marketing servers for storage along with data relating to other customers. Next in step 1675 the consolidated demographic data from customers is transmitted to participating retailers wherein on step 1680 retailers can distribute offers to customers. The process then proceeds to step 1690 wherein the customer is offered by some retailers and/or coupon providers to sign-up to coupon services for subsequent inclusion in future customer activities. The process then proceeds to step 1695 and terminates prior to being re-started the next time the customer selects the software system and/or software

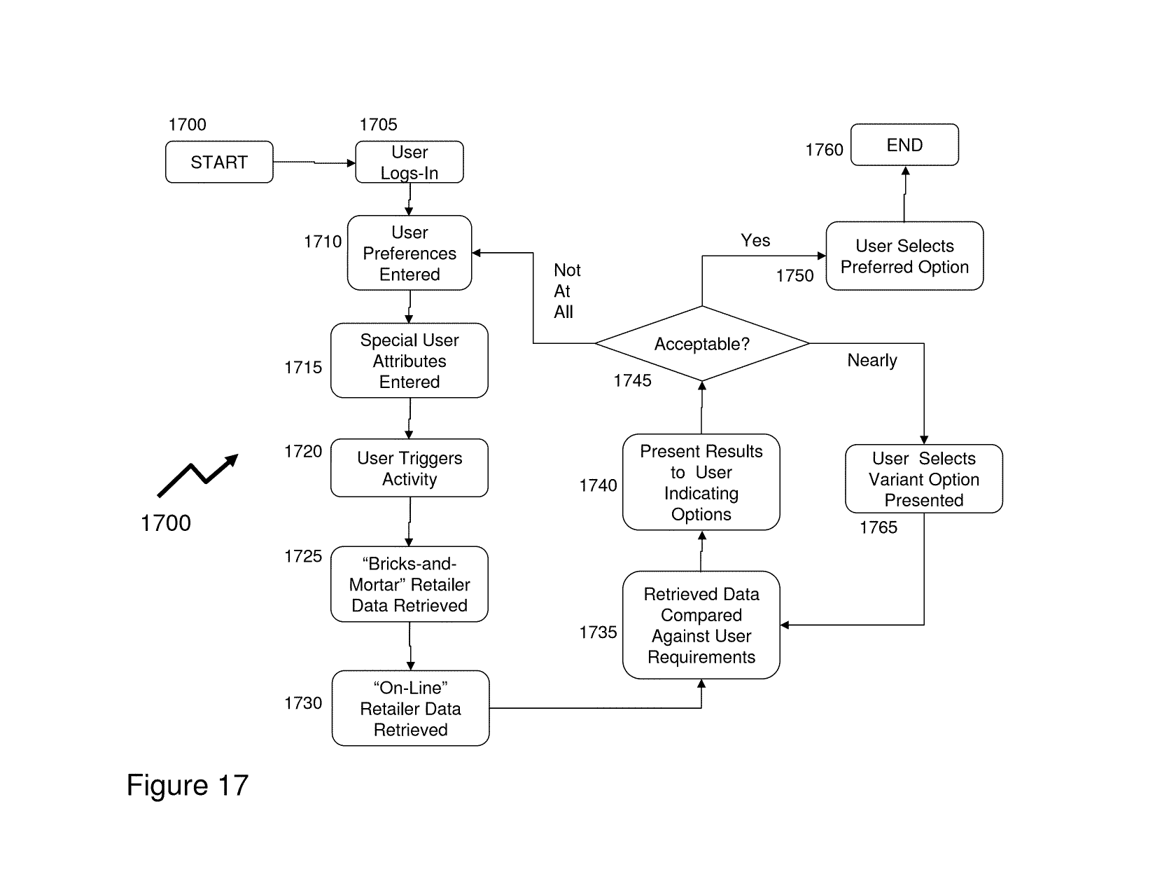

Referring to FIG. 17 there is depicted an exemplary process flow 1700 relating to an application according to an embodiment of the invention. Accordingly the process starts at step 1700 and proceeds to step 1705 wherein the user logs-in to the software application and/or software system wherein the process proceeds to step 1710 and the user preferences are entered followed by any special attributes in step 1715. Next in step 1720 the user triggers an activity, in this instance comparative retailer analysis, wherein first in step 1725 and subsequently in step 1730 the software application and/software system retrieves data from a plurality of physical retailers, so-called “bricks and mortar” retailers, and on-line retailers respectively. Next in step 1735 this retrieved data is compared with the data from the user's preferences which were entered in step 1710. The results of this comparison are then presented to the user in step 1740 wherein the user determines in step 1745 if any of the returned results are acceptable. If yes the process proceeds to step 1750 wherein the user selects their preferred option and this data is stored for use in a subsequent shopping list, retailer visit, on-line purchase, or a combination thereof together with other options which would evident to one skilled in the art before this process flow ends in step 1760.

If the results returned were nearly matching the user preferences and no acceptable retailer offer was available based upon the user determination in step 1755 then the process loops back to 1760 wherein the user may select a variant option presented to them by the software application and/or software system. For example, the user may have searched for 42″ LED televisions under $500 and is advised that there are no matches but that the search has identified 36″ to 40″ LED televisions under $500 and 42″ non-LED televisions under $500 wherein they are able to select one option. The flow returns to step 1735 and the modified user preferences form the basis for another comparison and presentation sequence to the user. If at step 1745 the user determines that none of the variants provided by the software application and/or software system are acceptable and there are no matching results the process loops back to step 1710 wherein the user may re-enter their preferences etc. For example, their initial search may have been geographically restricted, have been retailer specific, or identified that for retailers they wanted shipping included but now would consider store pick up.

It would be evident that where results and analysis are presented in respect of the embodiments of the invention as text renderings or graphics renderings that other rendering means of the results may be used including for example audiovisual rendering or multimedia rendering. Such multimedia or audiovisual rendering may include presentation of video-type sequences to guide the user through the retail environment wherein the user is unfamiliar with the environment, nervous, elderly etc.

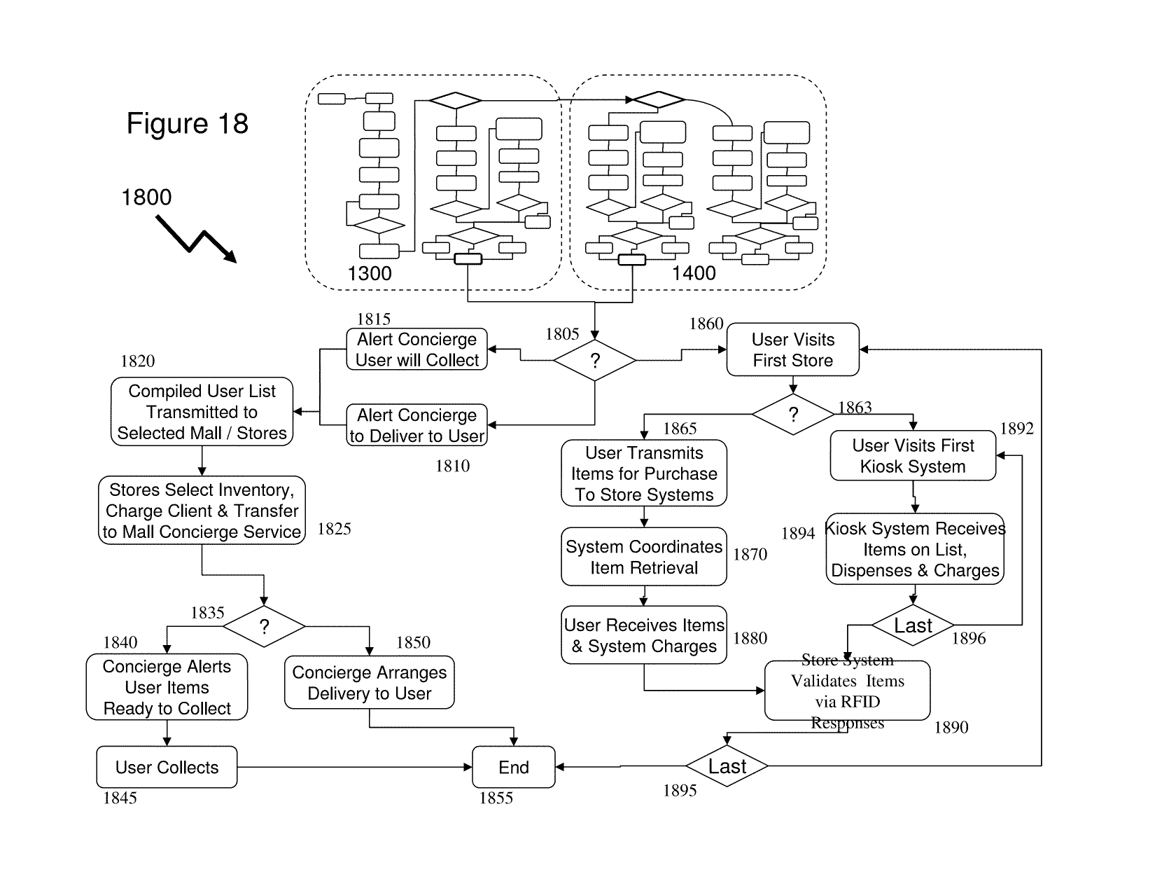

Now referring to FIG. 18 there is depicted a process flow 1800 according to an embodiment of the invention relating to a user accessing the software system and/or software application to select a list of items to purchase and their subsequent acquisition. The process begins with first process flow block 1300, which has been described above in respect of FIG. 13, which provides for completion of a user search wherein the process proceeds to step 1805 or progression to second process flow block 1400 which also provides an alternate path for a user to complete a search wherein the process proceeds to step 1805. Second process flow block 1400 being described above in respect of FIG. 14. Within first process flow block 1300 step End A 1370 links to step 1805 and within second process flow block 1400 step End B in first sub-flow 1420 links to step 1805. In step 1805 the process determines whether the user has elected to procure all the items on their list from a mall with delivery, from a mall with pick-up, or by visiting the mall. In the first instance the process proceeds to first concierge step 1815 wherein the concierge service at the mall is alerted that the user is purchasing the items from the stores within the mall and will be collecting items, in the second to second concierge step 1820 wherein the concierge is advised that the user is purchasing the items from the stores in the mall and that they are to be shipped to the user, and in the latter the process proceeds to step 1860 wherein the user visits the first store.

From first and second concierge steps 1810 and 1815 respectively the process proceeds to step 1820 wherein the compiled user list is transmitted to the selected mall and stores within. Next in step 1825 the stores retrieve the items selected by the user, charge the user and transfer them to the mall concierge service. In step 1835 the concierge service determines whether to notify the user that the items are available for collection in step 1840 which occurs next in step 1845 or arrange delivery to the user in step 1850. In either instance the process flow proceeds to step 1855 and ends. Where the user has decided to purchase the items directly and the user visits the first store in step 1860 then the process proceeds to step 1863 wherein it is determined whether the store provides consolidated retrieval or if the user must proceed to multiple locations in the store to retrieve the items on their list. In the instance that the user can obtain their purchases from a consolidated retrieval the process proceeds to step 1865 wherein the user transmits the items they wish to purchase at the store to the store systems such that in step 1870 the store systems coordinate retrieval and these can be collected by the user in step 1870 and is charged by the store. At this point as the user exits the store in step 1890 and the store systems validate the items via RFID responses, the process proceeds to step 1895 wherein the process determines whether another store remains for the user to visit in which case the process loops back to step 1860.

Where in step 1863 the process determines that the user will visit multiple locations the process proceeds to step 1892 wherein the user visits the first kiosk system and the kiosk system retrieves the items in the user's list through an ad-hoc association with the user's electronic device and dispenses them to the user together with charging them. Next is step 1896 the process determines whether the user has other kiosks to visit or not wherein it either loops back to step 1892 or proceeds to step 1890. At this point the process verifies the items via RFID responses and proceeds to step 1895 wherein it is determined whether the user has visited the last store wherein the process proceeds to step 1855 and ends otherwise it loops back to step 1860.

Within the embodiments of the invention described in FIG. 18 the user visiting the store engages automated product dispensing systems which either provide a coordinated retrieval and delivery to a user or are distributed within a retail environment. A wide variety of products a user purchases, especially in the food and beverage and pharmacy industries can be dispensed from automated systems. Such systems also allow non-traditional environments to provide retail solutions or increase the products offered in traditional retail environments. Additionally the process describes a verification step using RFID responses. Practically every product can be tagged using a passive RFID tag forming part of the product packaging such that as the user departs a store these are excited and their responses received and correlated to the user purchases to verify the user is departing with the correct number of items. As this may be a significant number of items, e.g. a grocery store, the passive RFID tags could provide large numbers of simultaneous responses. Accordingly, the passive RFID tags may be provided with pseudo-randomly allocated delays so that the responses are distributed in time allowing the processing system to isolate the individual items plus addressing a buyer purchasing multiple items of the same product. It would be evident to one skilled in the art that other techniques may be employed including but not limited to multiple RFID excitation frequencies, multiple RFID return frequencies, and distributed receivers to allow increased overall maximum delay for the pseudo-random delays.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
receiving at least a selection of a plurality of selections, each selection relating to at least one of a product or a service;
receiving at least a preference of a plurality of preferences, each preference relating to at least one of an aspect of the user, an aspect of a retailer defined by the user, and an aspect of a shopping environment defined by the user;
establishing with a microprocessor at least one correlation of a plurality of correlations, each correlation being generated in dependence upon at least one selection of the plurality of selections, at least one preference of the plurality of preferences, and at least one provider of a plurality of providers of the selection;
generating with the microprocessor at least one result of a plurality of results, each result generated in dependence upon the plurality of correlations; and
presenting the plurality of results to the user.

2. The method according to claim 1 further comprising;
receiving a selection from the user, the selection relating to a result of the plurality of results;
retrieving from a server predetermined data relating to the result, the predetermined data being established in dependence upon at least one preference of the plurality of the preferences;
processing with the microprocessor the predetermined data retrieved from the server to provide the user with processed data relating to the at least one preference of the plurality of preferences.

3. The method according to claim 1 wherein,
the aspect of the user relates to at least one of motion, time, and distance.

4. The method according to claim 1 wherein,
the aspect of the retailer defined by the user is at least one of a preference, a rejection, and a membership.

5. The method according to claim 1 wherein,
the aspect of the shopping environment defined by the user is at least one of a preference, a rejection, an opening time, and a closing time.

6. The method according to claim 1 wherein,
the result is at least one of a weighting of all the correlations and generated in dependence upon rankings relating to predetermined subsets of the correlations where the predetermined subsets are those relating to a preference of the plurality of preferences.

7. The method according to claim 1 wherein,
presenting the plurality of results to the user comprises generating at least one of a text based rendering, a graphics based rendering, a multimedia based rendering, and an audiovisual rendering.

8. The method according to claim 1 wherein,
the data provided by the user and to the user is provided from a device remote to the microprocessor and communicated to the microprocessor via a network.

9. A non-transitory tangible computer readable medium encoding a computer program for execution by the microprocessor, the computer program for executing a computer process comprising:
receiving at least a selection of a plurality of selections, each selection relating to at least one of a product or a service;
receiving at least a preference of a plurality of preferences, each preference relating to at least one of an aspect of the user, an aspect of a retailer defined by the user, and an aspect of a shopping environment defined by the user;
establishing with a microprocessor at least one correlation of a plurality of correlations, each correlation being generated in dependence upon at least one selection of the plurality of selections, at least one preference of the plurality of preferences, and at least one provider of a plurality of providers of the selection;
generating with the microprocessor at least one result of a plurality of results, each result generated in dependence upon the plurality of correlations; and
communicating the plurality of results to the user via a display forming part of an electronic device comprising a second microprocessor.

10. The method according to claim 9 further comprising;
receiving a selection from the user, the selection relating to a result of the plurality of results;
retrieving from a server predetermined data relating to the result, the predetermined data being established in dependence upon at least one preference of the plurality of the preferences;
processing with the microprocessor the predetermined data retrieved from the server to provide the user with processed data relating to the at least one preference of the plurality of preferences.

11. The method according to claim 9 wherein,
the aspect of the user relates to at least one of motion, time, and distance.

12. The method according to claim 9 wherein,
the aspect of the retailer defined by the user is at least one of a preference, a rejection, and a membership.

13. The method according to claim 9 wherein,
the aspect of the shopping environment defined by the user is at least one of a preference, a rejection, an opening time, and a closing time.

14. The method according to claim 9 wherein,
the result is at least one of a weighting of all the correlations and generated in dependence upon rankings relating to predetermined subsets of the correlations where the predetermined subsets are those relating to a preference of the plurality of preferences.

15. The method according to claim 9 wherein,
presenting the plurality of results to the user comprises generating at least one of a text based rendering, a graphics based rendering, a multimedia based rendering, and an audiovisual rendering.

16. The method according to claim 9 wherein,
the data provided by the user and to the user is provided from a device remote to the microprocessor and communicated to the microprocessor via a network.
